(19) United States
(12) Patent Application Publication
(10) Pub. No.: US 2026/0049917 A1
(43) Pub. Date: Feb. 19, 2026

(54) PARTICLE SIZE DISTRIBUTION ESTIMATION DEVICE, PARTICLE SIZE DISTRIBUTION ESTIMATION METHOD, AND NON-TRANSITORY COMPUTER-READABLE MEDIUM STORING PARTICLE SIZE DISTRIBUTION ESTIMATION PROGRAM

(71) Applicant: TOHOKU UNIVERSITY, Sendai-shi (JP)

(72) Inventors: Tomoaki SATOMI, Sendai-shi (JP); Yusuke KOBAYASHI, Sendai-shi (JP); Hiroshi TAKAHASHI, Sendai-shi (JP)

(73) Assignee: TOHOKU UNIVERSITY, Sendai-shi (JP)

(21) Appl. No.: 19/303,560

(22) Filed: Aug. 19, 2025

(30) Foreign Application Priority Data
Aug. 19, 2024 (JP) 2024-137869
Jun. 30, 2025 (JP) 2025-111022

(51) Int. Cl. G01N 15/0227; G06T 7/13; G06T 7/60

(52) U.S. Cl. CPC G01N 15/0227; G06T 7/13; G06T 7/60

(57) ABSTRACT

A particle size distribution estimation device includes: captured image acquisition processor circuitry configured to acquire a captured image that is an image generated by imaging a target region including a plurality of granular particles at least partially overlapping each other; a binary image generator configured to perform, on the captured image, binarizing that converts a value corresponding to each of a plurality of pixels constituting the captured image into a first value or a second value based on a threshold value, and thus to generate a binary image; a corrected binary image generator configured to perform, on the binary image, opening including eroding and dilating, the eroding and the dilating being filtering using a kernel, and thus to generate a corrected binary image.

### CROSS-REFERENCE TO THE RELATED APPLICATION

This application claims priority under 35 U.S.C. 119 from Japanese Patent Application No. 2024-137869, filed on Aug. 19, 2024, the contents of which are incorporated by reference herein.

### TECHNICAL FIELD

The present disclosure relates to a particle size distribution estimation device, a particle size distribution estimation method, and a non-transitory computer-readable medium storing a particle size distribution estimation program.

### BACKGROUND

A particle size distribution estimation device is known that estimates a particle size distribution, which is a distribution of particle sizes of a plurality of granular particles (for example, stones), based on a captured image, which is an image generated by imaging a target region including the plurality of granular particles at least partially overlapping each other. For example, a particle size distribution estimation device described in JP 2014-95644 A performs binarizing on a captured image to generate a binary image, extracts a contour of each of granular particles based on the binary image, and estimates a particle size of each granular particle based on the extracted contour.

### SUMMARY

Now, a plurality of granular particles at least partially overlap each other. In addition, the plurality of granular particles often have colors close to each other. Thus, in a binary image, an entire granular particle group in which the granular particles are close to each other may be erroneously extracted as the contour of one granular particle. Thus, in the particle size distribution estimation device, the contour of each granular particle cannot be extracted with high accuracy, and as a result, there is a possibility that the particle size distribution cannot be estimated with high accuracy in some cases.

An object of the present disclosure is to estimate a particle size distribution with high accuracy.

According to an aspect of the present disclosure, a particle size distribution estimation device includes a captured image acquisition unit, a binary image generation unit, a corrected binary image generation unit, a boundary information generation unit, a contour group information generation unit, and a particle size distribution estimation unit.

The captured image acquisition unit acquires a captured image that is an image generated by imaging a target region including a plurality of granular particles at least partially overlapping each other.

The binary image generation unit performs, on the captured image, binarizing that converts a value corresponding to each of a plurality of pixels constituting the captured image into a first value or a second value based on a threshold value, and thus generates a binary image.

The corrected binary image generation unit performs, on the binary image, opening including eroding and dilating, which are filtering using a kernel, and thus generates a corrected binary image.

The boundary information generation unit performs, on the corrected binary image, boundary extracting that extracts a boundary between a region having the first value and a region having the second value, and thus generates boundary information representing the boundary.

The contour group information generation unit performs, based on the boundary information, discarding that discards a contour candidate satisfying a predetermined discarding condition from among a contour candidate group that is a closed curve group included in the boundary represented by the boundary information, and thus generates contour group information representing a contour group that is a contour candidate group not satisfying the predetermined discarding condition among the contour candidate group.

The particle size distribution estimation unit estimates a particle size distribution that is a distribution of particle sizes of the plurality of granular particles, based on the contour group information.

According to another aspect, a particle size distribution estimation method includes:
acquiring a captured image that is an image generated by imaging a target region including a plurality of granular particles at least partially overlapping each other;
performing, on the captured image, binarizing that converts a value corresponding to each of a plurality of pixels constituting the captured image into a first value or a second value based on a threshold value, and thus generating a binary image;
performing, on the binary image, opening including eroding and dilating, which are filtering using a kernel, and thus generating a corrected binary image;
performing, on the corrected binary image, boundary extracting that extracts a boundary between a region having the first value and a region having the second value, and thus generating boundary information representing the boundary;
performing, based on the boundary information, discarding that discards a contour candidate satisfying a predetermined discarding condition from among a contour candidate group that is a closed curve group included in the boundary represented by the boundary information, and thus generating contour group information representing a contour group that is a contour candidate group not satisfying the predetermined discarding condition among the contour candidate group; and
estimating a particle size distribution that is a distribution of particle sizes of the plurality of granular particles, based on the contour group information.

According to another aspect, a non-transitory computer-readable medium storing a particle size distribution estimation program that, when executed by a computer, causes the computer to perform:
acquiring a captured image that is an image generated by imaging a target region including a plurality of granular particles at least partially overlapping each other;
binarizing, on the captured image, that converts a value corresponding to each of a plurality of pixels constituting the captured image into a first value or a second value based on a threshold value, and thus generating a binary image;
opening, on the binary image, including eroding and dilating, which are filtering using a kernel, and thus generating a corrected binary image;
boundary extracting, on the corrected binary image, that extracts a boundary between a region having the first value and a region having the second value, and thus generating boundary information representing the boundary;
discarding, based on the boundary information, that discards a contour candidate satisfying a predetermined discarding condition from among a contour candidate group that is a closed curve group included in the boundary represented by the boundary information, and thus generating contour group information representing a contour group that is a contour candidate group not satisfying the predetermined discarding condition among the contour candidate group; and
estimating a particle size distribution that is a distribution of particle sizes of the plurality of granular particles, based on the contour group information.

A particle size distribution can be estimated with high accuracy.

### BRIEF DESCRIPTION OF DRAWINGS

FIG. 1 is a block diagram illustrating a configuration of a particle size distribution estimation device according to a first embodiment.

FIG. 2 is a block diagram illustrating functions of an information processing device according to the first embodiment.

FIG. 3 is a flowchart depicting processing to be performed by the information processing device according to the first embodiment.

FIG. 4 is a block diagram illustrating a configuration of a particle size distribution estimation device according to a first modification of the first embodiment.

FIG. 5 is a flowchart depicting processing to be performed by an information processing device according to the first modification of the first embodiment.

FIG. 6 is a block diagram illustrating a configuration of a particle size distribution estimation device according to a second modification of the first embodiment.

FIG. 7 is a flowchart partially depicting processing to be performed by an information processing device according to the second modification of the first embodiment.

FIG. 8 is a flowchart depicting processing to be performed by an information processing device according to a second embodiment.

FIG. 9 is a flowchart depicting processing to be performed by an information processing device according to a first modification of the second embodiment.

FIGS. 10A-10D are explanatory diagrams illustrating an example of a captured image subjected to pre-processing and a binary image.

FIGS. 11A-11B are explanatory diagrams illustrating an example of a binary image before opening and a corrected binary image after the opening.

FIGS. 12A-12B are explanatory diagrams illustrating an example of a corrected binary image before shape discarding and a corrected binary image in which contour candidates discarded by the shape discarding are reflected.

FIG. 13 is an explanatory diagram illustrating an example of an image in which a contour group indicated by contour group information is drawn by using solid lines in the captured image subjected to the pre-processing.

FIG. 14 is a graph illustrating an example of a particle size distribution.

FIG. 15 is a flowchart depicting processing to be performed by an information processing device according to a third embodiment.

FIG. 16 is a flowchart depicting processing to be performed by an information processing device according to a fourth embodiment.

FIG. 17 is a flowchart partially depicting processing to be performed by an information processing device according to a fifth embodiment.

FIG. 18A is an explanatory diagram illustrating an example of lines used for acquiring a luminance change parameter, and FIG. 18B is an example of a graph illustrating a change in luminance with respect to pixel position on a line.

FIGS. 19A-19B are explanatory diagrams illustrating an example of lines used for acquiring a luminance change parameter.

FIG. 20 is a flowchart partially depicting processing to be performed by an information processing device according to a first modification of the fifth embodiment.

FIG. 21 is a flowchart partially depicting processing to be performed by an information processing device according to a second modification of the fifth embodiment.

FIG. 22 is a graph illustrating an example of a change in resistance force with respect to bucket moving distance.

FIG. 23 is a flowchart partially depicting processing to be performed by an information processing device according to a third modification of the fifth embodiment.

FIGS. 24A-24B are flowchart partially depicting processing to be performed by an information processing device according to a fourth modification of the fifth embodiment.
FIG. 25 is a flowchart partially depicting processing to be performed by an information processing device according to a sixth embodiment.

FIG. 26 is a flowchart depicting processing to be performed by an information processing device according to a seventh embodiment.

### DESCRIPTION OF EMBODIMENTS

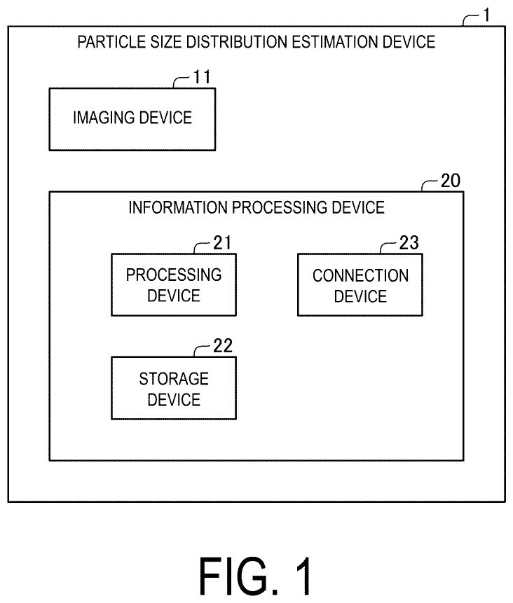

Hereinafter, embodiments related to a particle size distribution estimation device, a particle size distribution estimation method, and a non-transitory computer-readable medium storing a particle size distribution estimation program of the present disclosure will be described with reference to FIGS. 1 to 26.

### First Embodiment

### Overview

A particle size distribution estimation device according to a first embodiment includes a captured image acquisition unit, a binary image generation unit, a corrected binary image generation unit, a boundary information generation unit, a contour group information generation unit, and a particle size distribution estimation unit.

The captured image acquisition unit acquires a captured image that is an image generated by imaging a target region including a plurality of granular particles at least partially overlapping each other.

The binary image generation unit performs, on the captured image, binarizing that converts a value corresponding to each of a plurality of pixels constituting the captured image into a first value or a second value based on a threshold value, and thus generates a binary image.

The corrected binary image generation unit performs, on the binary image, opening including eroding and dilating, which are filtering using a kernel, and thus generates a corrected binary image.

The boundary information generation unit performs, on the corrected binary image, boundary extracting that extracts a boundary between a region having the first value and a region having the second value, and thus generates boundary information representing the boundary.

The contour group information generation unit performs, based on the boundary information, discarding that discards a contour candidate satisfying a predetermined discarding condition from among a contour candidate group that is a closed curve group included in the boundary represented by the boundary information, and thus generates contour group information representing a contour group that is a contour candidate group not satisfying the predetermined discarding condition among the contour candidate group.

The particle size distribution estimation unit estimates a particle size distribution that is a distribution of particle sizes of the plurality of granular particles, based on the contour group information.

According to this, the opening allows the contour of each granular particle to be reflected on the boundary extracted by the boundary extracting with high accuracy. Furthermore, the discarding makes it possible to appropriately discard the contour candidate corresponding to the entire contour of the granular particle group in which the granular particles are close to each other. Thus, the contour of each granular particle can be extracted with high accuracy. As a result, the particle size distribution can be estimated with high accuracy.

Next, the particle size distribution estimation device according to the first embodiment will be described in more detail.

### Configuration

As illustrated in FIG. 1, a particle size distribution estimation device 1 includes an imaging device 11 and an information processing device 20.

In this example, the particle size distribution estimation device 1 is mounted in or on a construction machine. Examples of the construction machine include an excavator or loader, such as a hydraulic excavator, a power shovel, a shovel loader, a shovel dozer, or a wheel loader. Note that the construction machine may be a transport machine such as a truck or a belt conveyor, or a bulldozer. Note that only a part of the particle size distribution estimation device 1 is mounted in or on a construction machine. In addition, the particle size distribution estimation device 1 may constitute a part of the construction machine.

In this example, the imaging device 11 and the information processing device 20 are separate from each other. Note that the imaging device 11 and the information processing device 20 may be integrated.

For example, the information processing device 20 may be represented as a computer. For example, the information processing device 20 may be at least a part of a smartphone, a television receiver, or the like. For example, the information processing device 20 may be a desktop computer, a laptop computer, a tablet computer, a smartphone, or the like. Note that the information processing device 20 may be constituted by a plurality of devices communicably connected to each other.

The imaging device 11 images a target region in response to an imaging command, thereby generating a captured image that is an image representing the imaged target region, and outputting the generated captured image. In this example, the target region is a predetermined region on a placement surface on which a plurality of granular particles at least partially overlapping each other can be placed. In other words, in this example, the target region includes a plurality of granular particles at least partially overlapping each other. For example, the target region includes a plurality of granular particles loaded on a loading platform of a truck.

In this example, the granular particles are crushed stones. Note that the granular particles may be boulders, gravel, or sand.

In this example, the captured image is a visible light image. The visible light image is an image representing intensities of visible light reflected at the target region for a plurality of pixels. In this example, the plurality of pixels included in the visible light image are arrayed in a lattice shape.

In this example, the imaging device 11 includes a color camera or a red-green-blue (RGB) camera. Note that the imaging device 11 may be a monochrome camera. In this example, the captured image is a still image. Note that the captured image may be a moving image instead of a still image. In this case, the information processing device 20 may generate a still image from a moving image.

The information processing device 20 includes a processing device 21, a storage device 22, and a connection device 23, which are connected to each other via a bus.

The processing device 21 controls the storage device 22 and the connection device 23 by executing a program stored in the storage device 22. Thus, the processing device 21 implements functions, which will be described later.

In this example, the processing device 21 is a central processing unit (CPU). Note that the processing device 21 may include a micro processing unit (MPU), a graphics processing unit (GPU), or a digital signal processor (DSP) instead of the CPU or in addition to the CPU.

In this example, examples of the storage device 22 include a volatile memory and a nonvolatile memory. For example, the storage device 22 includes at least one of a random access memory (RAM), a read only memory (ROM), a semiconductor memory, an organic memory, a hard disk drive (HDD), and a solid state drive (SSD).

The connection device 23 is communicably connected to an external device of the information processing device 20 in a wired or wireless manner. In this example, the connection device 23 is communicably connected to the imaging device 11 in a wired manner. The connection device 23 transmits an imaging command to the imaging device 11. The imaging command is information for triggering imaging of the target region. The connection device 23 receives the captured image output by the imaging device 11, and thus, is input with the captured image.

### Functions

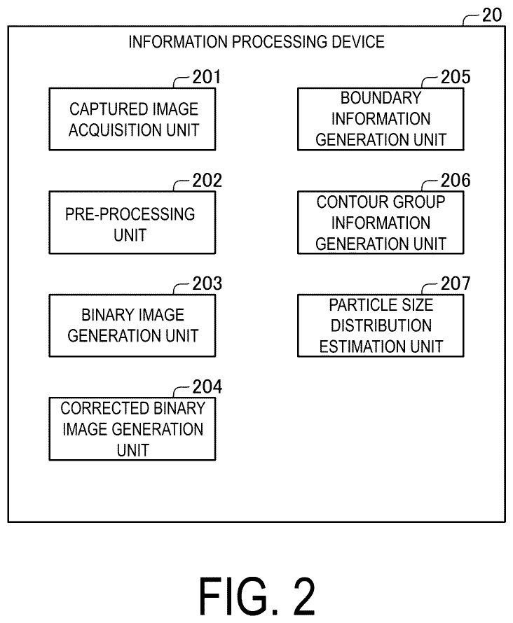

As illustrated in FIG. 2, functions of the information processing device 20 include a captured image acquisition unit 201, a pre-processing unit 202, a binary image generation unit 203, a corrected binary image generation unit 204, a boundary information generation unit 205, a contour group information generation unit 206, and a particle size distribution estimation unit 207. Note that the functions of the information processing device 20 need not include the pre-processing unit 202.

The captured image acquisition unit 201 transmits an imaging command to the imaging device 11, and then, receives a captured image output from the imaging device 11 to acquire the captured image (in other words, accepts the captured image).

The pre-processing unit 202 performs predetermined pre-processing on the captured image acquired by the captured image acquisition unit 201. In this example, the pre-processing includes trimming and filtering to be performed subsequent to the trimming.

The trimming is processing of cutting out a part of the captured image such that an object other than granular particles is not included. In this example, the captured image subjected to the trimming includes 500 pixels on a short side and 730 pixels on a long side. Note that the size of the captured image subjected to the trimming may be different from that in this example.

The filtering is processing of applying a bilateral filter to the captured image subjected to the trimming such that shades based on the unevenness of the surfaces of the granular particles are suppressed. In this example, the bilateral filter is repeatedly applied a plurality of times in the filtering. The pre-processing need not include any one of the trimming and the filtering.

The binary image generation unit 203 performs binarizing on the captured image subjected to the pre-processing by the pre-processing unit 202, and thus generates a binary image.

The binarizing is processing of converting a value corresponding to each of the plurality of pixels constituting the captured image into a first value or a second value based on a threshold value. In this example, the first value represents black, and the second value represents white. For example, the first value is 0 and the second value is 255.

In this example, the threshold value is set in advance. For example, the threshold value is a value from 100 to 150. Note that the binary image generation unit 203 may determine the threshold value based on the captured image. For example, the binary image generation unit 203 may determine the threshold value in accordance with a p-tile method, a mode method, a method called Otsu's binarization, or a method called adaptive binarization.

The corrected binary image generation unit 204 performs opening on the binary image generated by the binary image generation unit 203, and thus generates a corrected binary image. In this example, the opening includes N times of eroding and N times of dilating to be performed subsequent to the N times of eroding. N represents an integer of 1 or more. In this example, N represents 1.

The eroding is filtering in which, for each of the plurality of pixels constituting the binary image, when at least one of pixels included in a region of a kernel centered at a target pixel that is the pixel has the first value, the value of the target pixel is replaced with the first value. In other words, the eroding is filtering using a kernel. The eroding is processing also referred to as erosion.

The dilating is filtering in which, for each of the plurality of pixels constituting the binary image, when at least one of pixels included in a region of a kernel centered at a target pixel that is the pixel has the second value, the value of the target pixel is replaced with the second value. In other words, the dilating is filtering using a kernel. The dilating is processing also referred to as dilation.

In this example, the kernel is square. Note that the kernel may be a rectangle other than a square, a circle, an ellipse, or the like. In this example, the size of the kernel is set in advance. For example, the size of the kernel is set such that one side of the kernel is 10 to 40 pixels. Note that the size of the kernel may be set according to the size of the binary image. Additionally, the size of the kernel may be referred to as a kernel size.

The boundary information generation unit 205 performs boundary extracting on the corrected binary image generated by the corrected binary image generation unit 204, and thus generates boundary information.

The boundary extracting is processing of extracting a boundary between a region having the first value and a region having the second value. The boundary information represents the boundary between the region having the first value and the region having the second value.

The contour group information generation unit 206 performs discarding based on the boundary information generated by the boundary information generation unit 205, and thus, generates contour group information.

The discarding is processing of discarding a contour candidate satisfying a predetermined discarding condition from among a contour candidate group that is a closed curve group included in the boundary represented by the boundary information. The contour group information represents a contour group that is a contour candidate group not satisfying the discarding condition among the contour candidate group.

In this example, the discarding is a shape discarding of discarding the contour candidate based on the shape of the contour candidate. The shape discarding is processing of discarding a contour candidate satisfying a predetermined shape discarding condition from among a contour candidate group that is a closed curve group included in the boundary represented by the boundary information. In this example, the shape discarding condition includes a first shape discarding condition and a second shape discarding condition. Note that the shape discarding condition may include only one of the first shape discarding condition and the second shape discarding condition. In this example, the shape discarding condition corresponds to the discarding condition.

In this example, the shape discarding condition is satisfied when at least one of the first shape discarding condition and the second shape discarding condition is satisfied. Note that the shape discarding condition may be satisfied when both the first shape discarding condition and the second shape discarding condition are satisfied.

The first shape discarding condition is a condition that a circularity parameter, which increases as the shape of the contour candidate to be determined whether to be discarded approaches a circle, is outside a first range. In this example, a circularity parameter K_{FU} is expressed by Equation 1. The circularity parameter may be expressed as an irregularity index.

$${K}_{FU} = \frac{4 π A}{{L}^{2}} \qquad [ Math . 1 ]$$

A represents an area inside the contour candidate. L represents a perimeter of the contour candidate. The first range is a range that is larger than a first lower limit value and less than a first upper limit value. In this example, the first lower limit value is 55%, and the first upper limit value is 85%. Note that at least one of the first lower limit value and the first upper limit value may be different from that in this example.

The second shape discarding condition is a condition that a rectangularity parameter, which increases as the shape of the contour candidate to be determined whether to be discarded approaches a rectangle, is outside a second range. In this example, a rectangularity parameter K_{RE} is expressed by Equation 2. The rectangularity parameter may be represented as a rectangularity index.

$${K}_{RE} = \frac{A}{{A}_{rect}} \qquad [ Math . 2 ]$$

Arect represents an area inside the smallest rectangle surrounding the contour candidate. The second range is a range that is larger than a second lower limit value and less than a second upper limit value. In this example, the second lower limit value is 60%, and the second upper limit value is 90%. Note that at least one of the second lower limit value and the second upper limit value may be different from that in this example.

The particle size distribution estimation unit 207 estimates a particle size distribution, which is a distribution of particle sizes of a plurality of granular particles in the target region, based on the contour group information generated by the contour group information generation unit 206. In this example, the particle size distribution is a particle size cumulative curve. The particle size cumulative curve represents a change in percentage passing by mass with respect to particle size. The percentage passing by mass at a certain particle size is a rate of the mass of the granular particles having particle sizes smaller than the certain particle size with respect to the mass of all the granular particles.

In this example, the particle size distribution estimation unit 207 estimates the particle size cumulative curve by estimating, based on the area inside each contour constituting the contour group represented by the contour group information, the mass and the particle size of the granular particle corresponding to the contour.

The mass of the granular particle is estimated by multiplying the area inside the contour by a predetermined first coefficient. The particle size of the granular particle is estimated by multiplying the square root of the area by a predetermined second coefficient so as to match the diameter of a circle having the same area as the area inside the contour.

Note that at least one of the first coefficient and the second coefficient may be set according to the number of pixels in a captured image having a reference length.

Further, the information processing device 20 may output the estimated particle size distribution (for example, display the estimated particle size distribution on a display).

### Operation

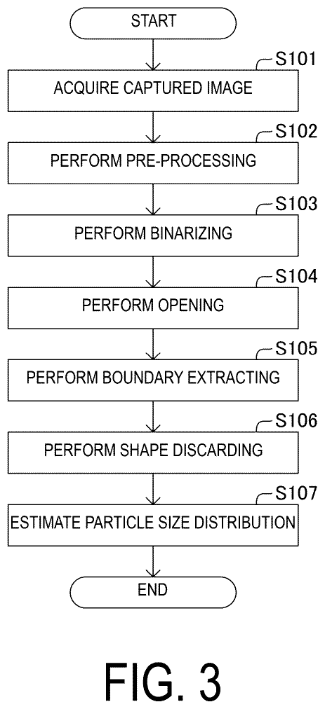

Next, the operation of the particle size distribution estimation device 1 will be described with reference to FIG. 3.

The particle size distribution estimation device 1 starts processing represented by a flowchart in FIG. 3.

First, the information processing device 20 transmits an imaging command to the imaging device 11, and receives a captured image output from the imaging device 11, thereby acquiring the captured image (step S101).

Next, the information processing device 20 performs pre-processing on the captured image acquired in step S101 (step S102). Next, the information processing device 20 performs binarizing on the captured image subjected to the pre-processing in step S102, thereby generating a binary image (step S103).

Next, the information processing device 20 performs opening on the binary image generated in step S103, thereby generating a corrected binary image (step S104). Next, the information processing device 20 performs boundary extracting on the corrected binary image generated in step S104, thereby generating boundary information (step S105).

Next, the information processing device 20 performs shape discarding based on the boundary information generated in step S105, thereby generating contour group information (step S106). Next, the information processing device 20 estimates a particle size distribution based on the contour group information generated in step S106 (step S107).

Thus, the information processing device 20 ends the processing illustrated in FIG. 3.

As described above, the particle size distribution estimation device 1 according to the first embodiment includes the captured image acquisition unit 201, the binary image generation unit 203, the corrected binary image generation unit 204, the boundary information generation unit 205, the contour group information generation unit 206, and the particle size distribution estimation unit 207.

The captured image acquisition unit 201 acquires a captured image that is an image generated by imaging a target region including a plurality of granular particles at least partially overlapping each other.

The binary image generation unit 203 performs, on the captured image, binarizing that converts a value corresponding to each of a plurality of pixels constituting the captured image into a first value or a second value based on a threshold value, thereby generating a binary image.

The corrected binary image generation unit 204 performs opening including eroding and dilating, which are filtering using a kernel, on the binary image, thereby generating a corrected binary image.

The boundary information generation unit 205 performs, on the corrected binary image, boundary extracting that extracts a boundary between a region having the first value and a region having the second value, thereby generating boundary information representing the boundary.

The contour group information generation unit 206 performs, based on the boundary information, discarding of discarding a contour candidate satisfying a predetermined discarding condition from among a contour candidate group that is a closed curve group included in the boundary represented by the boundary information, thereby generating contour group information representing a contour group that is a contour candidate group not satisfying the discarding condition among the contour candidate group.

The particle size distribution estimation unit 207 estimates a particle size distribution, which is a distribution of particle sizes of the plurality of granular particles, based on the contour group information.

According to this, the opening allows the contour of each granular particle to be reflected on the boundary extracted by the boundary extracting with high accuracy. Furthermore, the discarding makes it possible to appropriately discard the contour candidate corresponding to the entire contour of the granular particle group in which the granular particles are close to each other. Thus, the contour of each granular particle can be extracted with high accuracy. As a result, the particle size distribution can be estimated with high accuracy.

Furthermore, in the particle size distribution estimation device 1 of the first embodiment, the discarding condition includes at least one of a first shape discarding condition that a circularity parameter, which increases as the shape of the contour candidate to be determined approaches a circle, is outside a first range, and a second shape discarding condition that a rectangularity parameter, which increases as the shape of the contour candidate to be determined approaches a rectangle, is outside a second range.

It is often observed that the shape of the contour of the granular particle has a circularity parameter within a predetermined range. In addition, the shape of the contour of the granular particle often has a rectangularity parameter within a predetermined range. Considering these, according to the particle size distribution estimation device 1, the contour candidate is discarded when the circularity parameter is outside the first range. Moreover, the contour candidate is discarded when the rectangularity parameter is outside the second range. Thus, the contour candidate having a low possibility of being the shape of the contour of the granular particle is discarded. This makes it possible to appropriately discard the contour candidate corresponding to the entire contour of the granular particle group in which the granular particles are close to each other. Accordingly, the contour of each granular particle can be extracted with high accuracy. As a result, the particle size distribution can be estimated with high accuracy.

### First Modification of First Embodiment

Next, a particle size distribution estimation device according to a first modification of the first embodiment will be described. The particle size distribution estimation device according to the first modification of the first embodiment is different from the particle size distribution estimation device according to the first embodiment in that a particle size distribution is estimated based on a plurality of captured images individually generated by imaging a target region in a plurality of states having different positions of at least one or some of the plurality of granular particles from each other. The difference will be mainly described below. Note that in the description of the first modification of the first embodiment, the same reference numerals as those used in the first embodiment denote the same or substantially similar constituent elements.

### Configuration

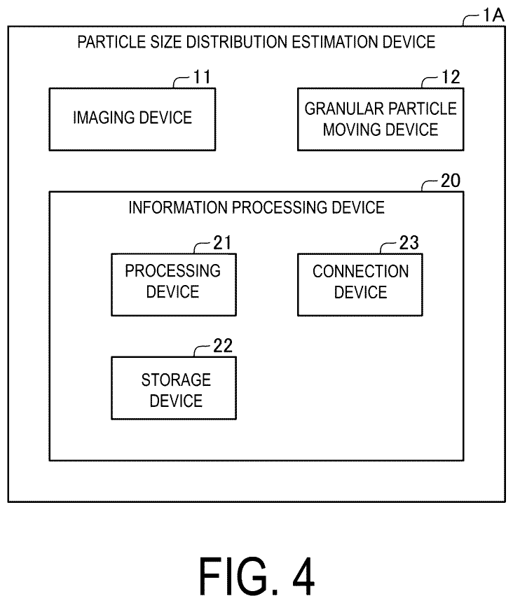

As illustrated in FIG. 4, a particle size distribution estimation device 1A according to the first modification of the first embodiment includes a granular particle moving device 12 in addition to the configuration included in the particle size distribution estimation device 1 according to the first embodiment.

The granular particle moving device 12 moves at least one or some of a plurality of granular particles in a target region. In this example, the granular particle moving device 12 corresponds to a granular particle moving unit.

In this example, the granular particle moving device 12 is a bucket of a construction machine. In this example, the imaging device 11 is positioned so as to face the granular particle moving device 12. Note that the imaging device 11 may be mounted in or on the granular particle moving device 12.

### Functions

A captured image acquisition unit 201 of the first modification of the first embodiment acquires a plurality of captured images individually generated by imaging a target region in a plurality of states having different positions of at least one or some of a plurality of granular particles from each other due to movement of the granular particles by the granular particle moving device 12.

A pre-processing unit 202 of the first modification of the first embodiment performs pre-processing on each of the plurality of captured images acquired by the captured image acquisition unit 201.

A binary image generation unit 203 of the first modification of the first embodiment performs binarizing on each of the plurality of captured images subjected to the pre-processing by the pre-processing unit 202, thereby generating a plurality of binary images.

A corrected binary image generation unit 204 of the first modification of the first embodiment performs opening on each of the plurality of binary images generated by the binary image generation unit 203, thereby generating a plurality of corrected binary images.

A boundary information generation unit 205 of the first modification of the first embodiment performs boundary extracting on each of the plurality of corrected binary images generated by the corrected binary image generation unit 204, thereby generating a plurality of pieces of boundary information.

A contour group information generation unit 206 of the first modification of the first embodiment performs discarding based on each of the plurality of pieces of boundary information generated by the boundary information generation unit 205, thereby generating a plurality of pieces of contour group information.

A particle size distribution estimation unit 207 of the first modification of the first embodiment estimates a particle size distribution based on the plurality of pieces of contour group information generated by the contour group information generation unit 206.

### Operation

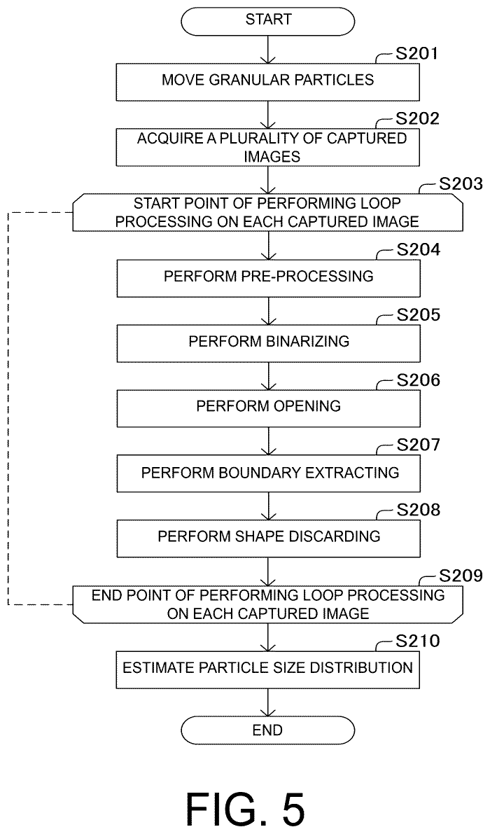

The particle size distribution estimation device 1A according to the first modification of the first embodiment starts processing illustrated in FIG. 5 instead of the processing illustrated in FIG. 3.

The granular particle moving device 12 moves at least one or some of a plurality of granular particles in a target region (step S201).

The information processing device 20 individually transmits M imaging commands to the imaging device 11 at M time points different from each other in a period in which the granular particle moving device 12 moves the granular particles, and receives M captured images output from the imaging device 11 to acquire the M captured images (step S202). M represents an integer of 2 or more. In this example, M represents 3.

Next, the information processing device 20 performs loop processing (step S203 to step S209) using each of the M captured images acquired in step S202 as a processing target one by one in order.

In the loop processing, the information processing device 20 performs the pre-processing, the binarizing, the opening, the boundary extracting, and the shape discarding on the captured image to be processed, as in steps S102 to S106 in FIG. 3 (steps S204 to S208).

Then, the information processing device 20 performs the loop processing (steps S203 to S209) on all of the acquired M captured images, and then proceeds to step S210.

Next, the information processing device 20 estimates a particle size distribution based on contour group information generated in step S208 for each of the M captured images (step S210). After that, the information processing device 20 ends the processing illustrated in FIG. 5.

As described above, the particle size distribution estimation device 1A according to the first modification of the first embodiment exhibits functions and effects similar to those of the particle size distribution estimation device 1 according to the first embodiment.

Furthermore, the particle size distribution estimation device 1A according to the first modification of the first embodiment includes a granular particle moving unit (in this example, the granular particle moving device 12) that moves at least one or some of the plurality of granular particles in the target region.

The captured image acquisition unit 201 acquires a plurality of captured images individually generated by imaging a target region in a plurality of states having different positions of at least one or some of the plurality of granular particles from each other due to movement of the granular particles by the granular particle moving device 12. The binary image generation unit 203 performs binarizing on each of the plurality of captured images, thereby generating a plurality of binary images.

The corrected binary image generation unit 204 performs opening on each of the plurality of binary images, thereby generating a plurality of corrected binary images. The boundary information generation unit 205 performs boundary extracting on each of the plurality of corrected binary images, thereby generating a plurality of pieces of boundary information.

The contour group information generation unit 206 performs discarding based on each of the plurality of pieces of boundary information, thereby generating a plurality of pieces of contour group information. The particle size distribution estimation unit 207 estimates a particle size distribution based on the plurality of pieces of contour group information.

According to this, the contour of each granular particle is extracted based on the plurality of captured images of the plurality of granular particles in different overlapping states. This makes it possible to increase the number of granular particles whose contours are extracted. As a result, the particle size distribution can be estimated with high accuracy.

### Second Modification of First Embodiment

Next, a particle size distribution estimation device according to a second modification of the first embodiment will be described. The particle size distribution estimation device according to the second modification of the first embodiment is different from the particle size distribution estimation device according to the first modification of the first embodiment in that a resistance force received by the granular particle moving unit due to movement of granular particles is detected and the size of a kernel is determined based on the detected resistance force. The difference will be mainly described below. Note that in the description of the second modification of the first embodiment, the same reference numerals as those used in the first modification of the first embodiment denote the same or substantially similar constituent elements.

### Configuration

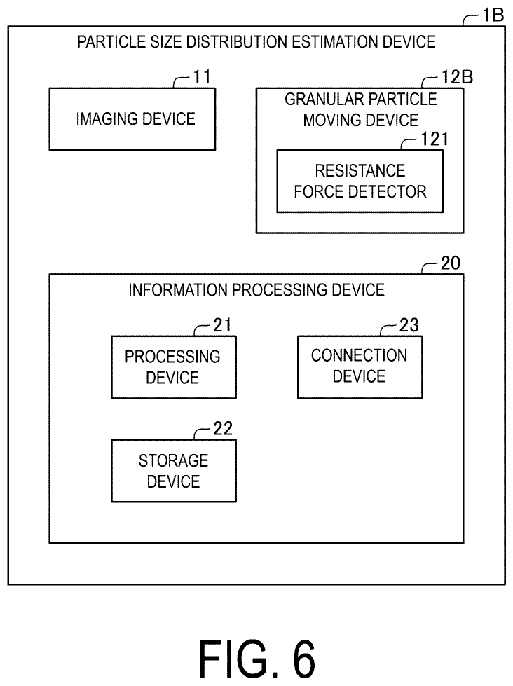

As illustrated in FIG. 6, a particle size distribution estimation device 1B according to the second modification of the first embodiment includes a granular particle moving device 12B instead of the granular particle moving device 12 according to the first modification of the first embodiment.

The granular particle moving device 12B moves at least one or some of a plurality of granular particles in a target region, similarly to the granular particle moving device 12. In this example, the granular particle moving device 12B corresponds to a granular particle moving unit.

In this example, the granular particle moving device 12B is a bucket of a construction machine. In this example, the granular particle moving device 12B is driven by hydraulic pressure. Note that the granular particle moving device 12B may be driven by electric power. In this example, the imaging device 11 is positioned so as to face the granular particle moving device 12B. Note that the imaging device 11 may be mounted in or on the granular particle moving device 12B.

The granular particle moving device 12B includes a resistance force detector 121. The resistance force detector 121 detects a resistance force that the granular particle moving device 12B receives due to movement of granular particles. In this example, the granular particle moving device 12B detects the resistance force by detecting the magnitude of a hydraulic pressure that drives the granular particle moving device 12B. In this example, the resistance force detector 121 corresponds to a resistance force detection unit.

### Functions

A corrected binary image generation unit 204 of the second modification of the first embodiment determines the size of a kernel to be used in opening based on the resistance force detected by the resistance force detector 121. In this example, the corrected binary image generation unit 204 determines the size of the kernel such that the size of the kernel is smaller as the detected resistance force is smaller.

For example, the corrected binary image generation unit 204 determines the size of the kernel such that one side of the kernel has pixels of a first pixel number when the detected resistance force is larger than a predetermined resistance force threshold value, and determines the size of the kernel such that one side of the kernel has pixels of a second pixel number smaller than the first pixel number when the resistance force is equal to or smaller than the resistance force threshold value. Note that the size of the kernel may be determined such that one side of the kernel has pixels of a pixel number selected from among a pixel number group of three or more pixels. In this case, two or more resistance force threshold values may be provided.

### Operation

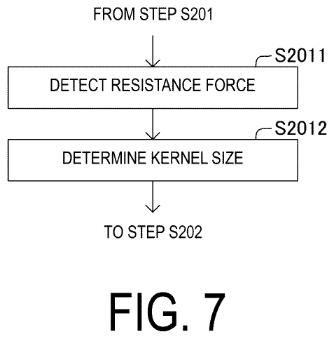

The particle size distribution estimation device 1B according to the second modification of the first embodiment performs processing in which processing of step S2011 and step S2012 illustrated in FIG. 7 is added between step S201 and step S202 of the processing illustrated in FIG. 5.

Thus, after the granular particle moving device 12B starts moving at least one or some of a plurality of granular particles in a target region in step S201, the resistance force detector 121 detects a resistance force received by the granular particle moving device 12B due to movement of the granular particles in a period in which the granular particle moving device 12B moves the granular particles (step S2011).

Next, the information processing device 20 determines the size of a kernel to be used in opening based on the resistance force detected in step S2011 (step S2012). Next, the information processing device 20 performs the processing of step S202 to step S210, similarly to the information processing device 20 according to the first modification of the first embodiment.

As described above, the particle size distribution estimation device 1B according to the second modification of the first embodiment exhibits functions and effects similar to those of the particle size distribution estimation device 1A according to the first modification of the first embodiment.

Furthermore, the particle size distribution estimation device 1B according to the second modification of the first embodiment includes a resistance force detection unit (in this example, the resistance force detector 121) that detects a resistance force received by a granular particle moving unit (in this example, the granular particle moving device 12B) due to movement of granular particles. The corrected binary image generation unit 204 determines the size of a kernel such that the size of the kernel is smaller as the detected resistance force is smaller.

Now, the smaller the average value of particle sizes, the smaller a resistance force in many cases. In addition, the smaller the average value of particle sizes, the smaller the appropriate size of a kernel in many cases. Thus, according to the particle size distribution estimation device 1B, the contour of each of the granular particles can be extracted with high accuracy. As a result, the particle size distribution can be estimated with high accuracy.

Note that the particle size distribution estimation device 1B according to the second modification of the first embodiment may estimate a particle size distribution based on one captured image.

### Second Embodiment

Next, a particle size distribution estimation device according to a second embodiment will be described. The particle size distribution estimation device according to the second embodiment is different from the particle size distribution estimation device according to the first embodiment in that a plurality of binary images are generated by performing binarizing for each of a plurality of threshold values different from each other, and a particle size distribution is estimated based on the plurality of binary images generated. The difference will be mainly described below. Note that in the description of the second embodiment, the same reference numerals as those used in the first embodiment denote the same or substantially similar constituent elements.

### Functions

A binary image generation unit 203 of the second embodiment performs binarizing for each of a plurality of threshold values different from each other, thereby generating a plurality of binary images. The plurality of threshold values are set such that a difference between two adjacent threshold values matches a predetermined difference amount within a luminance range of a captured image. In this example, a difference amount is 5. Note that the difference amount may be a value other than 5. For example, when the luminance range of the captured image is from 110 to 120, the plurality of threshold values are set to 110, 115, and 120. Note that the plurality of threshold values may be set in advance.

A corrected binary image generation unit 204 of the second embodiment performs opening on each of the plurality of binary images generated by the binary image generation unit 203, thereby generating a plurality of corrected binary images.

A boundary information generation unit 205 of the second embodiment performs boundary extracting on each of the plurality of corrected binary images generated by the corrected binary image generation unit 204, thereby generating a plurality of pieces of boundary information.

A contour group information generation unit 206 of the second embodiment performs discarding based on the plurality of pieces of boundary information generated by the boundary information generation unit 205, thereby generating contour group information.

The discarding is processing of discarding a contour candidate satisfying a predetermined discarding condition from among a contour candidate group that is a closed curve group included in the boundary represented by the boundary information. The contour group information represents a contour group that is a contour candidate group not satisfying the discarding condition among the contour candidate group.

In this example, the discarding includes shape discarding of discarding a contour candidate based on the shape of the contour candidate and duplicate discarding of discarding a duplicate contour candidate.

In this example, the contour group information generation unit 206 performs shape discarding based on each of the plurality of pieces of boundary information generated by the boundary information generation unit 205, thereby generating contour candidate group information. The contour candidate group information represents a contour candidate group not satisfying a shape discarding condition among a contour candidate group that is a closed curve group included in the boundary represented by the boundary information.

The shape discarding is processing of discarding a contour candidate satisfying a predetermined shape discarding condition from among the contour candidate group that is the closed curve group included in the boundary represented by the boundary information. In this example, the shape discarding condition includes a first shape discarding condition and a second shape discarding condition. The first shape discarding condition and the second shape discarding condition are similar to the first shape discarding condition and the second shape discarding condition of the first embodiment. Note that the shape discarding condition may include only one of the first shape discarding condition and the second shape discarding condition. In this example, the shape discarding condition corresponds to a part of the discarding condition.

In this example, the shape discarding condition is satisfied when at least one of the first shape discarding condition and the second shape discarding condition is satisfied. Note that the shape discarding condition may be satisfied when both the first shape discarding condition and the second shape discarding condition are satisfied.

In this example, the contour group information generation unit 206 performs duplicate discarding based on each of a contour candidate group information pair constituted by two pieces of contour candidate group information generated for two adjacent threshold values in the plurality of pieces of contour candidate group information generated by the shape discarding, thereby generating contour group information.

The duplicate discarding is processing of discarding a contour candidate satisfying a predetermined duplicate discarding condition from among the contour candidate group represented by the contour candidate group information so as to discard a duplicate contour candidate from among the contour candidate group information constituting the contour candidate group information pair. The duplicate discarding condition is a condition that the center of another contour candidate is included inside a contour candidate to be determined whether or not to be discarded. In this example, the duplicate discarding condition corresponds to a part of the discarding condition.

In this example, in the duplicate discarding, the contour candidates constituting the contour candidate group represented by the contour candidate group information based on the binary image generated based on a larger threshold value of the two pieces of contour candidate group information constituting the contour candidate group information pair are targets to be determined whether or not to be discarded.

In this example, in the duplicate discarding, whether or not the duplicate discarding condition is satisfied is determined in accordance with the Crossing Number Algorithm. Note that in the duplication discarding, whether or not the duplicate discarding condition is satisfied may be determined in accordance with the Winding Number Algorithm instead of the Crossing Number Algorithm.

### Operation

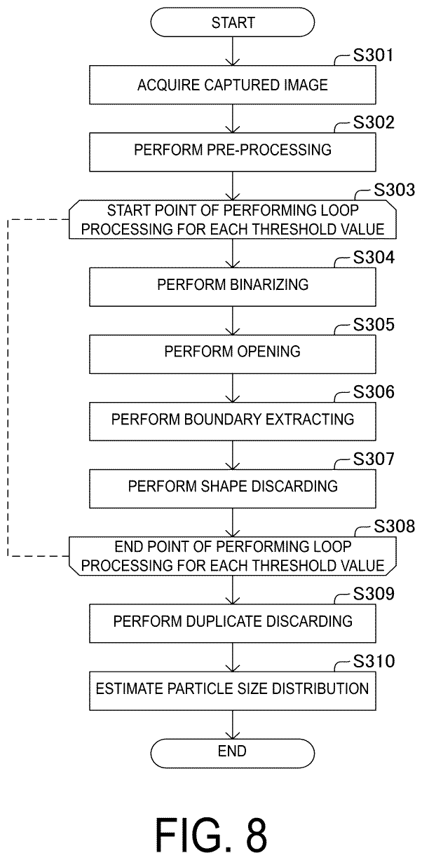

The particle size distribution estimation device 1 according to the second embodiment starts processing illustrated in FIG. 8 instead of the processing illustrated in FIG. 3.

The information processing device 20 acquires a captured image and performs pre-processing on the captured image, similarly to step S101 and step S102 in FIG. 3 (step S301 and step S302).

Next, the information processing device 20 performs loop processing (step S303 to step S308) using each of P threshold values to be processed one by one in order. P represents an integer of 2 or more.

In the loop processing, the information processing device 20 performs binarizing, opening, and boundary extracting for the threshold value to be processed, similarly to step S103 to step S105 in FIG. 3 (step S304 to step S306). Next, in the loop processing, the information processing device 20 performs shape discarding based on the boundary information generated in step S306 for the threshold value to be processed, thereby generating contour candidate group information (step S307).

Then, the information processing device 20 performs the loop processing described above (step S303 to step S308) for all of the P threshold values, and then proceeds to step S309.

Next, the information processing device 20 performs duplicate discarding based on the contour candidate group information generated in step S307 for each of the P threshold values, thereby generating contour group information (step S309).

Next, the information processing device 20 estimates a particle size distribution based on the contour group information generated in step S309 (step S310).

After that, the information processing device 20 ends the processing illustrated in FIG. 8.

Note that the processing of step S309 may be performed immediately after step S307 in the loop processing.

As described above, the particle size distribution estimation device 1 according to the second embodiment exhibits functions and effects similar to those of the particle size distribution estimation device 1 according to the first embodiment.

Furthermore, in the particle size distribution estimation device 1 according to the second embodiment, the binary image generation unit 203 performs binarizing for each of a plurality of threshold values different from each other, thereby generating a plurality of binary images. The corrected binary image generation unit 204 performs opening on each of the plurality of binary images, thereby generating a plurality of corrected binary images.

The boundary information generation unit 205 performs boundary extracting on each of the plurality of corrected binary images, thereby generating a plurality of pieces of boundary information. The contour group information generation unit 206 performs discarding based on the plurality of pieces of boundary information, thereby generating contour group information. The discarding condition includes a duplicate discarding condition that the center of another contour candidate is included inside a contour candidate to be determined.

Incidentally, a granular particle whose contour is extracted often varies according to the threshold value used in the binarizing. Thus, performing the binarizing for each of the plurality of different threshold values from each other makes it possible to increase the number of granular particles whose contours are extracted. Furthermore, when the center of another contour candidate is included inside a contour candidate, the contour candidate is discarded, allowing extraction of a plurality of contours for an identical granular particle to be suppressed. This makes it possible to appropriately discard the contour candidate corresponding to the entire contour of the granular particle group in which the granular particles are close to each other. Accordingly, the contour of each granular particle can be extracted with high accuracy. As a result, the particle size distribution can be estimated with high accuracy.

### First Modification of Second Embodiment

Next, a particle size distribution estimation device according to a first modification of the second embodiment will be described. The particle size distribution estimation device according to the first modification of the second embodiment is different from the particle size distribution estimation device according to the second embodiment in that a particle size distribution is estimated based on a plurality of captured images individually generated by imaging a target region in a plurality of states having different positions of at least one or some of a plurality of granular particles from each other. The difference will be mainly described below. Note that in the description of the first modification of the second embodiment, the same reference numerals as those used in the second embodiment denote the same or substantially similar constituent elements.

### Configuration

As illustrated in FIG. 4, a particle size distribution estimation device 1A according to the first modification of the second embodiment includes the granular particle moving device 12 in addition to the configuration included in the particle size distribution estimation device 1 according to the second embodiment.

The granular particle moving device 12 moves at least one or some of the plurality of granular particles in a target region. In this example, the granular particle moving device 12 corresponds to a granular particle moving unit.

In this example, the granular particle moving device 12 is a bucket of a construction machine. In this example, the imaging device 11 is positioned so as to face the granular particle moving device 12. Note that the imaging device 11 may be mounted in or on the granular particle moving device 12.

### Functions

A captured image acquisition unit 201 of the first modification of the second embodiment acquires a plurality of captured images individually generated by imaging a target region in a plurality of states having different positions of at least one or some of the plurality of granular particles from each other due to movement of the granular particles by the granular particle moving device 12.

A pre-processing unit 202 of the first modification of the second embodiment performs pre-processing on each of the plurality of captured images acquired by the captured image acquisition unit 201.

A binary image generation unit 203 of the first modification of the second embodiment performs, for each captured image, binarizing on the captured image subjected to the pre-processing by the pre-processing unit 202 by using each of a plurality of threshold values different from each other, thereby generating a plurality of binary images.

A corrected binary image generation unit 204 of the first modification of the second embodiment performs, for each captured image, opening on each of the plurality of binary images generated by the binary image generation unit 203, thereby generating a plurality of corrected binary images.

A boundary information generation unit 205 of the first modification of the second embodiment performs, for each captured image, boundary extracting on each of the plurality of corrected binary images generated by the corrected binary image generation unit 204, thereby generating a plurality of pieces of boundary information.

A contour group information generation unit 206 of the first modification of the second embodiment performs, for each captured image, discarding based on each of the plurality of pieces of boundary information generated by the boundary information generation unit 205, thereby generating contour group information.

A particle size distribution estimation unit 207 of the first modification of the second embodiment estimates a particle size distribution based on a plurality of pieces of contour group information generated by the contour group information generation unit 206.

### Operation

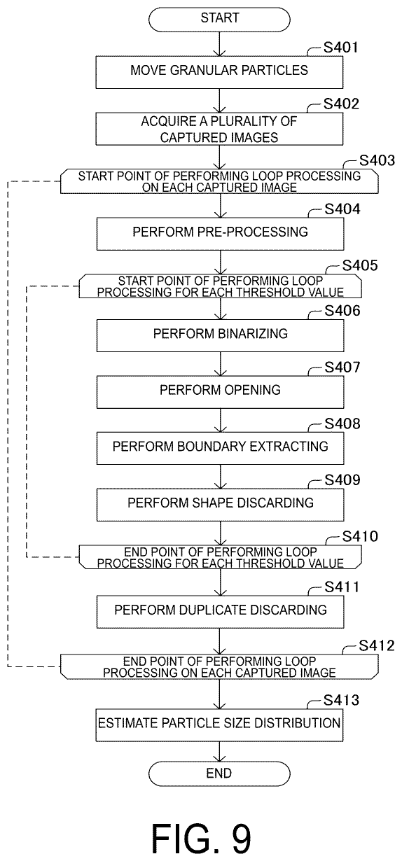

The particle size distribution estimation device 1A according to the first modification of the second embodiment starts processing illustrated in FIG. 9 instead of the processing illustrated in FIG. 8.

The granular particle moving device 12 moves at least one or some of a plurality of granular particles in a target region (step S401).

The information processing device 20 individually transmits M imaging commands to the imaging device 11 at M time points different from each other in a period in which the granular particle moving device 12 moves the granular particles, and receives M captured images output from the imaging device 11 to acquire the M captured images (step S402). M represents an integer of 2 or more. In this example, M represents 3.

Next, the information processing device 20 performs first loop processing (step S403 to step S412) in which each of the M captured images acquired in step S402 is used as a processing target one by one in order.

In the first loop processing, the information processing device 20 performs pre-processing on the captured image to be processed, as in step S302 in FIG. 8 (step S404).

Next, in the first loop processing, the information processing device 20 performs second loop processing (step S405 to step S410) using each of P threshold values as a processing target one by one in order. P represents an integer of 2 or more.

In the second loop processing, the information processing device 20 performs binarizing, opening, boundary extracting, and shape discarding for the threshold value as the processing target, as in steps S304 to S307 in FIG. 8 (step S406 to step S409).

Then, the information processing device 20 performs the second loop processing (step S405 to step S410) for all of the P threshold values, and then proceeds to step S411.

Next, the information processing device 20 performs duplicate discarding on the pieces of contour candidate group information generated in step S409 for the respective P threshold values, thereby generating contour group information for the captured image to be processed (step S411).

Then, the information processing device 20 performs the first loop processing (step S403 to step S412) on all the acquired M captured images, and then proceeds to step S413.

Next, the information processing device 20 estimates a particle size distribution based on the pieces of contour group information generated in step S411 for the respective M captured images (step S413).

After that, the information processing device 20 ends the processing illustrated in FIG. 9.

Note that the processing of step S411 may be performed immediately after step S409 in the first loop processing.

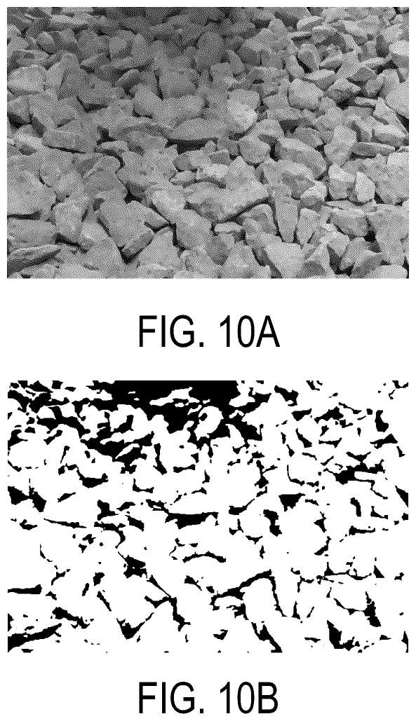

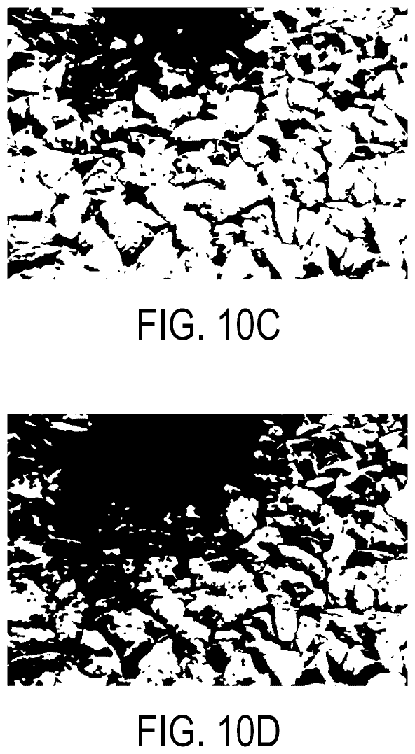

Here, an example of a result of the processing performed by the information processing device 20 will be described with reference to FIGS. 10A to 14.

FIG. 10A illustrates an example of a captured image subjected to the pre-processing. FIG. 10B illustrates an example of a binary image when a threshold value is 100. FIG. 10C illustrates an example of a binary image when a threshold value is 125. FIG. 10D illustrates an example of a binary image when a threshold value is 150.

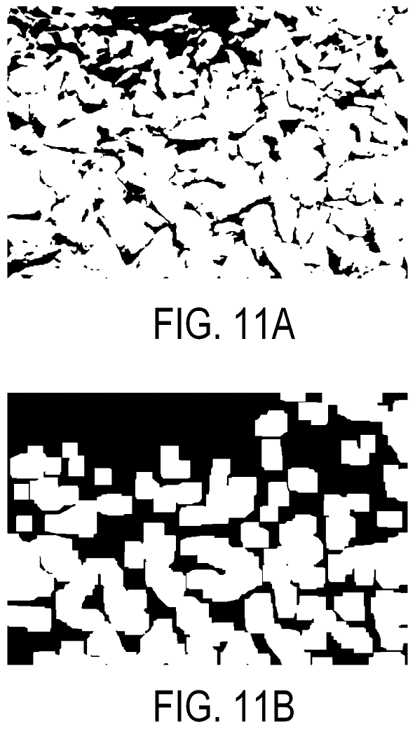

FIG. 11A illustrates an example of a binary image before the opening. FIG. 11B illustrates an example of a binary image subjected to the opening (in other words, a corrected binary image).

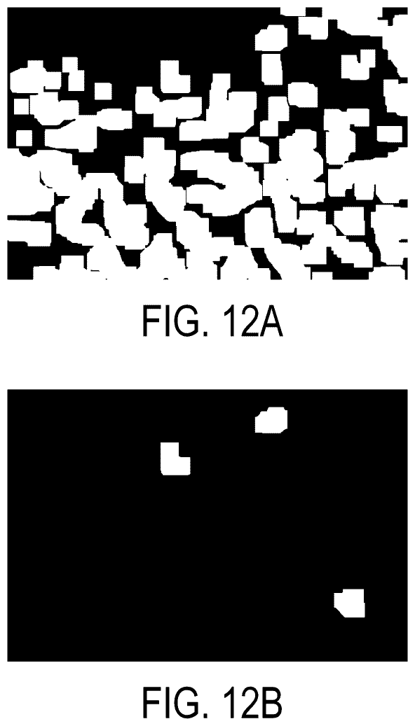

FIG. 12A illustrates an example of a corrected binary image before the shape discarding. FIG. 12B illustrates an example of a corrected binary image in which contour candidates discarded by the shape discarding are reflected.

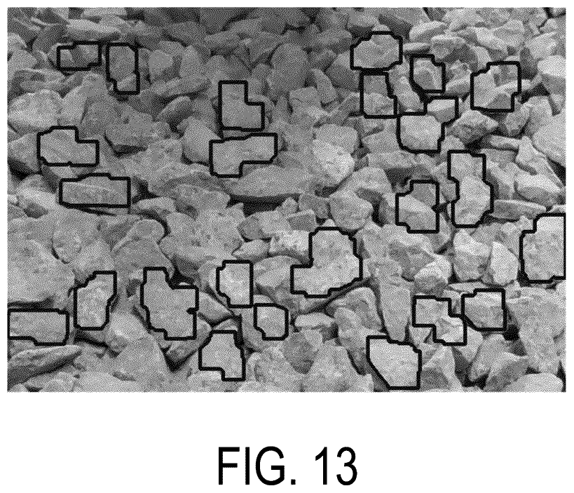

FIG. 13 illustrates an example of an image in which a contour group indicated by contour group information is drawn by solid lines in a captured image subjected to the pre-processing.

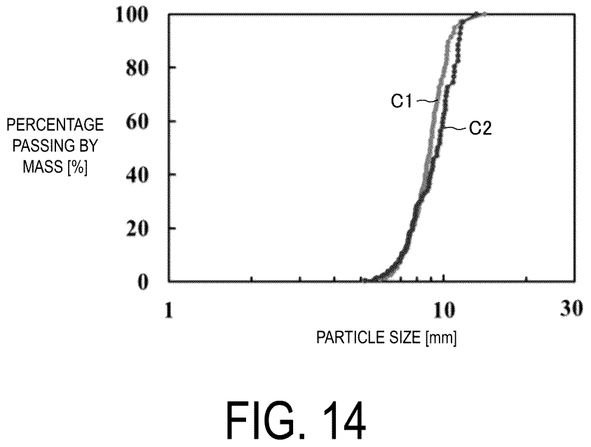

FIG. 14 illustrates an example of a particle size distribution (in this example, particle size cumulative curves). In FIG. 14, a curve Cl represents a measured particle size cumulative curve and a curve C2 represents an estimated particle size cumulative curve.

As described above, the particle size distribution estimation device 1A according to the first modification of the second embodiment exhibits functions and effects similar to those of the particle size distribution estimation device 1 according to the second embodiment.

Further, the particle size distribution estimation device 1A according to the first modification of the second embodiment includes a granular particle moving unit (in this example, the granular particle moving device 12) that moves at least one or some of a plurality of granular particles in a target region. The captured image acquisition unit 201 acquires a plurality of captured images individually generated by imaging a target region in a plurality of states having different positions of at least one or some of the plurality of granular particles from each other due to movement of the granular particles by the granular particle moving device 12.

The binary image generation unit 203 performs binarizing on each of the plurality of captured images, thereby generating a plurality of binary images. The corrected binary image generation unit 204 performs opening on each of the plurality of binary images, thereby generating a plurality of corrected binary images.

The boundary information generation unit 205 performs boundary extracting on each of the plurality of corrected binary images, thereby generating a plurality of pieces of boundary information. The contour group information generation unit 206 performs discarding based on each of the plurality of pieces of boundary information, thereby generating a plurality of pieces of contour group information. The particle size distribution estimation unit 207 estimates a particle size distribution based on the plurality of pieces of contour group information.

According to this, the contour of each granular particle is extracted based on the plurality of captured images of the plurality of granular particles in different overlapping states. This makes it possible to increase the number of granular particles whose contours are extracted. As a result, the particle size distribution can be estimated with high accuracy.

### Third Embodiment

Next, a particle size distribution estimation device according to a third embodiment will be described. The particle size distribution estimation device according to the third embodiment is different from the particle size distribution estimation device according to the first embodiment in that a plurality of corrected binary images are generated by performing opening individually for a plurality of kernel sizes different from each other, and a particle size distribution is estimated based on the generated plurality of corrected binary images. The difference will be mainly described below. Note that in the description of the third embodiment, the same reference numerals as those used in the first embodiment denote the same or substantially similar constituent elements.

### Functions

A corrected binary image generation unit 204 of the third embodiment performs opening for each of a plurality of sizes of kernels (in other words, kernel sizes) different from each other, thereby generating a plurality of corrected binary images. The plurality of kernel sizes are set in advance. In this example, the plurality of kernel sizes are set to a size in which one side of the kernel has 17 pixels and a size in which one side of the kernel has 31 pixels. Note that the plurality of kernel sizes may be set to sizes different from those in this example. For example, the plurality of kernel sizes may be set to a size in which one side of the kernel has 19 pixels and a size in which one side of the kernel has 31 pixels. Further, the number of kernel sizes may be three or more. For example, the plurality of kernel sizes may be set to a size in which one side of the kernel has 19 pixels, a size in which one side of the kernel has 27 pixels, and a size in which one side of the kernel has 31 pixels.

A boundary information generation unit 205 of the third embodiment performs boundary extracting on each of the plurality of corrected binary images generated by the corrected binary image generation unit 204, thereby generating a plurality of pieces of boundary information.

A contour group information generation unit 206 of the third embodiment performs discarding based on the plurality of pieces of boundary information generated by the boundary information generation unit 205, similarly to the contour group information generation unit 206 of the second embodiment, thereby generating contour group information.

### Operation

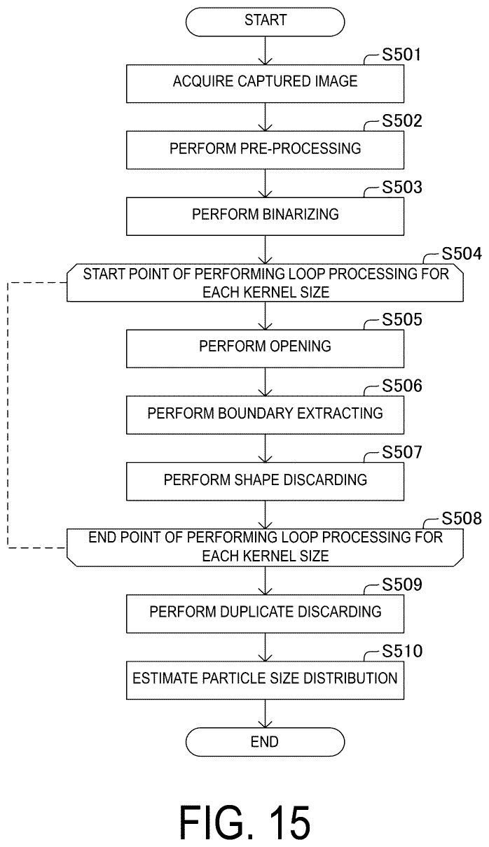

A particle size distribution estimation device 1 according to the third embodiment starts processing illustrated in FIG. 15 instead of the processing illustrated in FIG. 3. The information processing device 20 acquires a captured image and performs pre-processing and binarizing on the captured image, similarly to step S101 to step S103 in FIG. 3 (step S501 to step S503).

Next, the information processing device 20 performs loop processing using each of Q kernel sizes as a processing target one by one in order (step S504 to step S508). Q represents an integer of 2 or more.

In the loop processing, the information processing device 20 performs opening and boundary extracting for the kernel size as the processing target, similarly to step S104 and step S105 in FIG. 3 (step S505 and step S506). Next, in the loop processing, the information processing device 20 performs shape discarding based on the boundary information generated in step S506 for the kernel size as the processing target, thereby generating contour candidate group information (step S507).

Then, the information processing device 20 performs the loop processing (step S504 to step S508) for all of the Q kernel sizes, and then proceeds to step S509.

Next, the information processing device 20 performs duplicate discarding based on the pieces of contour candidate group information generated in step S507 for the respective Q kernel sizes, thereby generating contour group information (step S509).

Next, the information processing device 20 estimates a particle size distribution based on the contour group information generated in step S509 (step S510).

Thus, the information processing device 20 ends the processing illustrated in FIG. 15.

Note that the processing of step S509 may be performed immediately after step S507 in the loop processing.

As described above, the particle size distribution estimation device 1 according to the third embodiment exhibits functions and effects similar to those of the particle size distribution estimation device 1 according to the first embodiment.

Furthermore, in the particle size distribution estimation device 1 according to the third embodiment, the corrected binary image generation unit 204 performs opening for each of a plurality of kernel sizes different from each other, thereby generating a plurality of corrected binary images.

The boundary information generation unit 205 performs boundary extracting on each of the plurality of corrected binary images, thereby generating a plurality of pieces of boundary information. The contour group information generation unit 206 performs discarding based on the plurality of pieces of boundary information, thereby generating contour group information. The discarding condition includes a duplicate discarding condition that the center of another contour candidate is included inside a contour candidate to be determined.

Incidentally, a granular particle whose contour is extracted often varies according to the size of the kernel used in the opening. Thus, performing the opening for each of the plurality of kernels having different sizes can increase the number of granular particles whose contours are extracted. Furthermore, when the center of another contour candidate is included inside a contour candidate, the contour candidate is discarded, allowing extraction of a plurality of contours for an identical granular particle to be suppressed. This makes it possible to appropriately discard the contour candidate corresponding to the entire contour of the granular particle group in which the granular particles are close to each other. Accordingly, the contour of each granular particle can be extracted with high accuracy. As a result, the particle size distribution can be estimated with high accuracy.

Note that, similarly to the particle size distribution estimation device 1A according to the first modification of the first embodiment, a particle size distribution estimation device 1 according to a first modification of the third embodiment may estimate a particle size distribution based on a plurality of captured images individually generated by imaging a target region in a plurality of states having different positions of at least one or some of a plurality of granular particles from each other.

In addition, a particle size distribution estimation device 1 according to a second modification of the third embodiment may detect a resistance force received by a granular particle moving unit due to movement of granular particles and determine the size of a kernel based on the detected resistance force, similarly to the particle size distribution estimation device 1B according to the second modification of the first embodiment.

### Fourth Embodiment

Next, a particle size distribution estimation device according to a fourth embodiment will be described. The particle size distribution estimation device according to the fourth embodiment is different from the particle size distribution estimation device according to the second embodiment in that a plurality of corrected binary images are generated by performing opening, for each of a plurality of kernel sizes different from each other, on each of binary images generated corresponding to a plurality of threshold values different from each other, and a particle size distribution is estimated based on the generated plurality of corrected binary images. The difference will be mainly described below. Note that in the description of the fourth embodiment, the same reference numerals as those used in the second embodiment denote the same or substantially similar constituent elements.

### Functions

A corrected binary image generation unit 204 of the fourth embodiment performs opening for each of a plurality of sizes of kernels (in other words, kernel sizes) different from each other for each binary image generated by the binary image generation unit 203, thereby generating a plurality of corrected binary images. The plurality of kernel sizes are set in advance. In this example, the plurality of kernel sizes are set to a size in which one side of the kernel has 17 pixels and a size in which one side of the kernel has 31 pixels. Note that the plurality of kernel sizes may be set to sizes different from those in this example. For example, the plurality of kernel sizes may be set to a size in which one side of the kernel has 19 pixels and a size in which one side of the kernel has 31 pixels. Further, the number of kernel sizes may be three or more. For example, the plurality of kernel sizes may be set to a size in which one side of the kernel has 19 pixels, a size in which one side of the kernel has 27 pixels, and a size in which one side of the kernel has 31 pixels.

A boundary information generation unit 205 of the fourth embodiment performs boundary extracting on each of the plurality of corrected binary images generated for each binary image, thereby generating a plurality of pieces of boundary information.

A contour group information generation unit 206 of the fourth embodiment performs discarding on the plurality of pieces of boundary information generated for each binary image, thereby generating contour group information.

### Operation

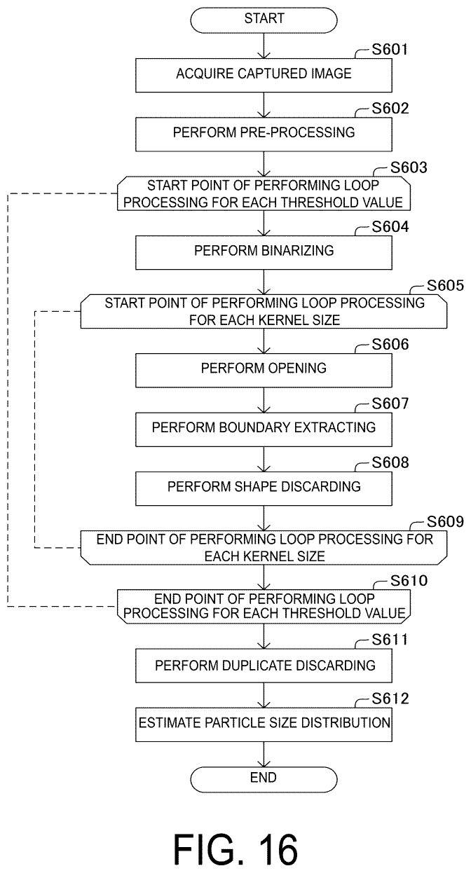

The particle size distribution estimation device 1 according to the fourth embodiment starts processing illustrated in FIG. 16 instead of the processing illustrated in FIG. 8.

The information processing device 20 acquires a captured image and performs pre-processing on the captured image, similarly to step S301 and step S302 in FIG. 8 (step S601 and step S602).

Next, the information processing device 20 performs first loop processing using each of P threshold values as a processing target one by one in order (step S603 to step S610). P represents an integer of 2 or more.

In the first loop processing, the information processing device 20 performs binarizing for the threshold value as the processing target, as in step S304 in FIG. 8 (step S604).

Next, the information processing device 20 performs second loop processing (step S605 to step S609) using each of Q kernel sizes as the processing target one by one in order. Q represents an integer of 2 or more.

In the second loop processing, the information processing device 20 performs opening and boundary extracting for the kernel size as the processing target, similarly to step S305 and step S306 in FIG. 8 (step S606 and step S607). Next, in the second loop processing, the information processing device 20 performs shape discarding based on the boundary information generated in step S607 for the kernel size as the processing target, thereby generating contour candidate group information (step S608).

Then, the information processing device 20 performs the second loop processing (step S605 to step S609) for all of the Q kernel sizes, and then proceeds to step S610.

Then, the information processing device 20 performs the first loop processing (steps S603 to S610) for all of the P threshold values, and then proceeds to step S611.

Next, the information processing device 20 performs, for each threshold value, duplicate discarding based on the pieces of contour candidate group information generated in step S608 for the respective Q kernel sizes, thereby generating contour group information (step S611).

Next, the information processing device 20 estimates a particle size distribution based on the contour group information generated in step S611 (step S612).

After that, the information processing device 20 ends the processing illustrated in FIG. 16.

Note that the processing of step S611 may be performed immediately after the second loop processing in the first loop processing, or may be performed immediately after step S608 in the second loop processing.

As described above, the particle size distribution estimation device 1 according to the fourth embodiment exhibits functions and effects similar to those of the particle size distribution estimation device 1 according to the second embodiment.

Furthermore, in the particle size distribution estimation device 1 according to the fourth embodiment, the corrected binary image generation unit 204 performs opening for each of a plurality of kernel sizes different from each other, thereby generating a plurality of corrected binary images.

The boundary information generation unit 205 performs boundary extracting on each of the plurality of corrected binary images, thereby generating a plurality of pieces of boundary information. The contour group information generation unit 206 performs discarding based on the plurality of pieces of boundary information, thereby generating contour group information. The discarding condition includes a duplicate discarding condition that the center of another contour candidate is included inside a contour candidate to be determined.

Incidentally, a granular particle whose contour is extracted often varies according to the size of the kernel used in the opening. Thus, performing the opening for each of the plurality of kernels having different sizes can increase the number of granular particles whose contours are extracted. Furthermore, when the center of another contour candidate is included inside a contour candidate, the contour candidate is discarded, allowing extraction of a plurality of contours for an identical granular particle to be suppressed. This makes it possible to appropriately discard the contour candidate corresponding to the entire contour of the granular particle group in which the granular particles are close to each other. Accordingly, the contour of each granular particle can be extracted with high accuracy. As a result, the particle size distribution can be estimated with high accuracy.

Note that, similarly to the particle size distribution estimation device 1A according to the first modification of the first embodiment, a particle size distribution estimation device 1 according to a first modification of the fourth embodiment may estimate a particle size distribution based on a plurality of captured images individually generated by imaging a target region in a plurality of states having different positions of at least one or some of a plurality of granular particles from each other.

In addition, a particle size distribution estimation device 1 according to a second modification of the fourth embodiment may detect a resistance force received by a granular particle moving unit due to movement of granular particles and determine the size of a kernel based on the detected resistance force, similarly to the particle size distribution estimation device 1B according to the second modification of the first embodiment.

### Fifth Embodiment

Next, a particle size distribution estimation device according to a fifth embodiment will be described. The particle size distribution estimation device according to the fifth embodiment is different from the particle size distribution estimation device according to the first embodiment in that the size of a kernel is determined based on a total distance of edges detected in a captured image. The difference will be mainly described below. Note that in the description of the fifth embodiment, the same reference numerals as those used in the first embodiment denote the same or substantially similar constituent elements.

### Functions

A corrected binary image generation unit 204 of the fifth embodiment detects edges in a captured image subjected to pre-processing by the pre-processing unit 202, and acquires a total edge distance that is a total distance of the detected edges. In this example, the corrected binary image generation unit 204 detects edges by using the Canny method (in other words, a Canny edge detector).

Note that the corrected binary image generation unit 204 may detect edges by using a Sobel filter, a Prewitt filter, a Roberts filter, a Laplacian filter, a Laplacian of Gaussian filter, or a Difference of Gaussians filter instead of the Canny method.

Further, the corrected binary image generation unit 204 may detect edges by using a method using deep learning (for example, Holistically-Nested Edge Detection, Richly Activated Convolutional Features, DexiNed, or the like).

The corrected binary image generation unit 204 determines the size of a kernel to be used in opening based on the acquired total edge distance. In this example, the corrected binary image generation unit 204 determines the size of the kernel such that the size of the kernel is smaller as the acquired total edge distance is longer.

### Operation

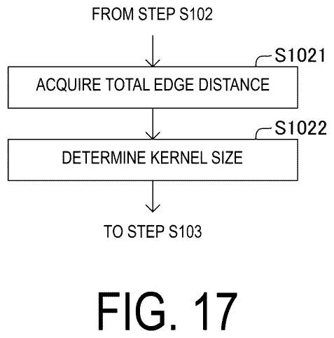

A particle size distribution estimation device 1 according to the fifth embodiment performs processing in which processing of step S1021 and step S1022 illustrated in FIG. 17 is added between step S102 and step S103 in the processing illustrated in FIG. 3.

Thus, the information processing device 20 performs pre-processing on a captured image, then detects edges in the captured image subjected to the pre-processing, and acquires a total edge distance, which is the total distance of the detected edges (step S1021).

Next, the information processing device 20 determines the size of a kernel to be used in opening based on the total edge distance acquired in step S1021 (step S1022). Next, the information processing device 20 performs processing of step S103 to step S107, similarly to the information processing device 20 according to the first embodiment.

As described above, the particle size distribution estimation device 1 according to the fifth embodiment exhibits functions and effects similar to those of the particle size distribution estimation device 1 according to the first embodiment.

Furthermore, in the particle size distribution estimation device 1 according to the fifth embodiment, the corrected binary image generation unit 204 determines the size of a kernel based on the total distance of edges detected in a captured image.

It should be noted that, the average value of particle sizes and a width of a particle size distribution (in other words, the particle size range in a particle size distribution) have a strong correlation with the total distance of edges. In addition, the average value of particle sizes and the width of a particle size distribution have a strong correlation also with an appropriate kernel size. Thus, according to the particle size distribution estimation device 1, the contour of each granular particle can be extracted with high accuracy. As a result, the particle size distribution can be estimated with high accuracy.

Furthermore, in the particle size distribution estimation device 1 according to the fifth embodiment, the corrected binary image generation unit 204 determines the size of a kernel such that the size of the kernel is smaller as the total distance of edges detected in a captured image is longer.

Incidentally, the smaller the average value of particle sizes, the longer the total distance of edges in many cases. In addition, the smaller the average value of particle sizes, the smaller the appropriate size of a kernel in many cases. Thus, according to the particle size distribution estimation device 1, the contour of each granular particle can be extracted with high accuracy. As a result, the particle size distribution can be estimated with high accuracy.

In this example, since the opening is performed for the size of one kernel (in other words, a kernel size), a processing load can be suppressed as compared with a case where the opening is performed for each of a plurality of kernel sizes.

Note that, similarly to the particle size distribution estimation device 1 according to the second embodiment, the particle size distribution estimation device 1 according to the fifth embodiment may perform binarizing for each of a plurality of threshold values different from each other, then generate a plurality of binary images, and thus estimate a particle size distribution based on the generated plurality of binary images.

In addition, the particle size distribution estimation device 1 according to the fifth embodiment may estimate a particle size distribution based on a plurality of captured images individually generated by imaging a target region in a plurality of states having different positions of at least one or some of a plurality of granular particles from each other, similarly to the particle size distribution estimation device 1A according to the first modification of the first embodiment.

In this case, the corrected binary image generation unit 204 may acquire the size of a kernel for each of a plurality of captured images based on the total distance of edges detected in the captured image, and use the size of the kernel acquired for the captured image in the opening for the captured image.

In this case, the corrected binary image generation unit 204 may acquire the size of a kernel for each of a plurality of captured images based on the total distance of edges detected in the captured image, and determine the average value of a plurality of kernel sizes acquired for the plurality of captured images as the size of a kernel to be used in the opening for all of the plurality of captured images.

### First Modification of Fifth Embodiment

Next, a particle size distribution estimation device according to a first modification of the fifth embodiment will be described. The particle size distribution estimation device according to the first modification of the fifth embodiment is different from the particle size distribution estimation device according to the fifth embodiment in that the size of a kernel is determined based on a luminance change parameter acquired based on a change in luminance along a predetermined line in a captured image. The difference will be mainly described below. In the description of the first modification of the fifth embodiment, the same reference numerals as those used in the fifth embodiment denote the same or substantially similar constituent elements.

### Functions

A corrected binary image generation unit 204 according to the first modification of the fifth embodiment acquires a luminance change parameter based on a change in luminance along a predetermined line in a captured image subjected to pre-processing by the pre-processing unit 202.

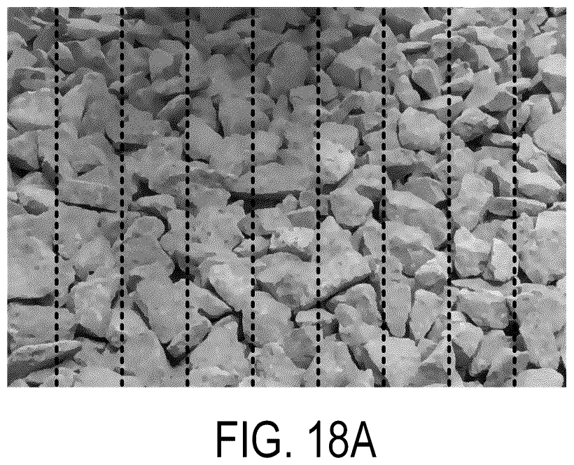

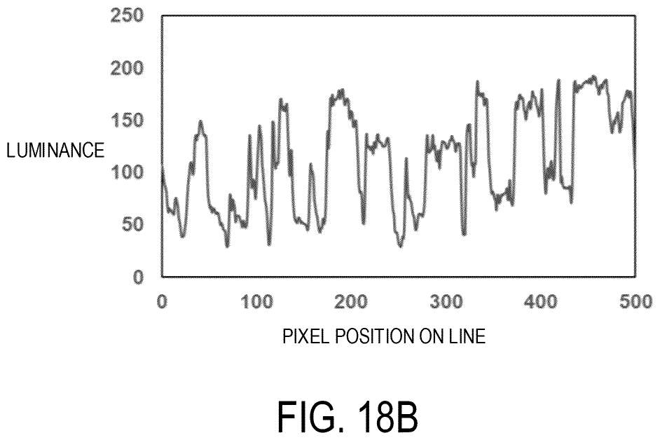

In this example, as indicated by dotted lines in FIG. 18A, the predetermined line in the captured image is constituted by a plurality of (eight in this example) straight lines extending in a vertical direction. In this example, the plurality of straight lines are positioned at equal intervals in a horizontal direction. The predetermined line in the captured image may be constituted by one straight line or a plurality of straight lines other than eight straight lines.

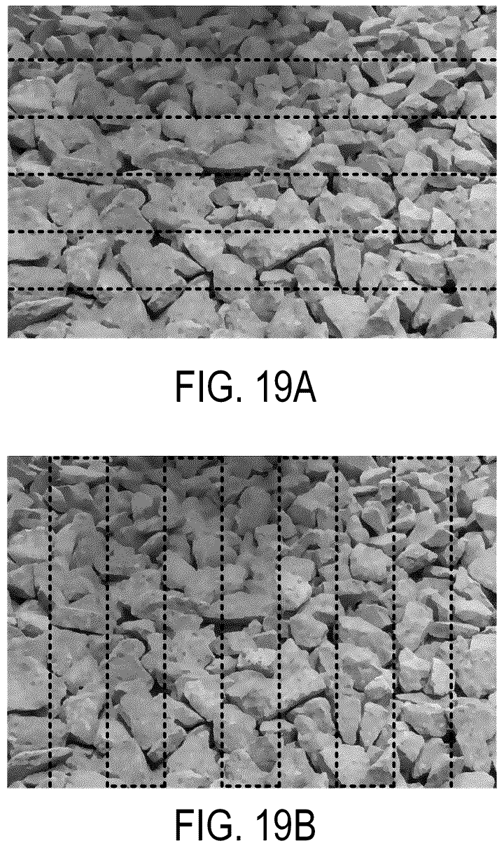

Further, as indicated by dotted lines in FIG. 19A, the predetermined line in the captured image may be constituted by a plurality of (five in this example) straight lines extending in the horizontal direction. In this case, the predetermined line in the captured image may be constituted by one straight line or may be constituted by a plurality of straight lines other than five straight lines.

In addition, the predetermined line in the captured image may be a curved line. For example, as indicated by a dotted line in FIG. 19B, the predetermined line in the captured image may be a polygonal curve in which a plurality of straight lines extending in the vertical direction are connected to each other at ends in the vertical direction.

Further, the predetermined line in the captured image may be a combination of a straight line and a curved line.

FIG. 18B is a graph illustrating an example of the change in luminance with respect to pixel position on a line. The pixel position on a line represents a pixel position along a predetermined line in the captured image. In this example, the pixel position on a line represents the number of pixels counted from a start point toward an end point of the predetermined line in the captured image.

In this example, a luminance change parameter is the number of peaks in the change in luminance with respect to pixel position on a line (in other words, the number of luminance change peaks). Note that the luminance change parameter may be the frequency range in a power spectrum acquired by performing frequency analysis on the change in luminance with respect to the pixel position on a line. For example, the frequency range may be a full width at half maximum, or may be a frequency range where power is equal to or larger than a predetermined threshold value.

The corrected binary image generation unit 204 determines the size of a kernel to be used in opening based on the acquired luminance change parameter. In this example, the corrected binary image generation unit 204 determines the size of the kernel such that the size of the kernel is smaller as the acquired luminance change parameter is larger.

### Operation

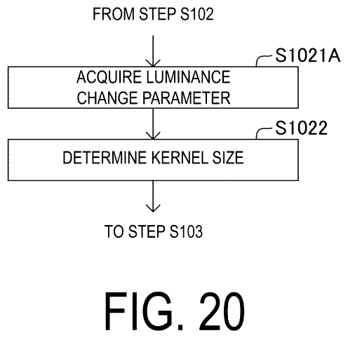

A particle size distribution estimation device 1 according to the first modification of the fifth embodiment performs processing in which processing of step S1021A and step S1022 illustrated in FIG. 20 is added between step S102 and step S103 of the processing illustrated in FIG. 3.

Thus, the information processing device 20 performs pre-processing on a captured image, and then acquires a luminance change parameter in the captured image subjected to the pre-processing (step S1021A).

Next, the information processing device 20 determines the size of a kernel to be used in opening based on the luminance change parameter acquired in step S1021A (step S1022). Next, the information processing device 20 performs processing of step S103 to step S107, similarly to the information processing device 20 according to the first embodiment.

As described above, the particle size distribution estimation device 1 according to the first modification of the fifth embodiment exhibits functions and effects similar to those of the particle size distribution estimation device 1 according to the first embodiment.

Furthermore, in the particle size distribution estimation device 1 according to the first modification of the fifth embodiment, the corrected binary image generation unit 204 determines the size of a kernel based on a luminance change parameter acquired based on a change in luminance along a predetermined line in a captured image.

It is worth noting that the average value of particle sizes and the width of a particle size distribution (in other words, the particle size range in a particle size distribution) have a strong correlation with a luminance change parameter. In addition, the average value of particle sizes and the width of a particle size distribution have a strong correlation also with an appropriate kernel size. Thus, according to the particle size distribution estimation device 1, the contour of each granular particle can be extracted with high accuracy. As a result, the particle size distribution can be estimated with high accuracy.

Further, in the particle size distribution estimation device 1 according to the first modification of the fifth embodiment, the corrected binary image generation unit 204 determines the size of a kernel such that the size of the kernel is smaller as the number of luminance change peaks acquired in a captured image is larger.

Incidentally, the smaller the average value of particle sizes, the larger the number of luminance change peaks in many cases. In addition, the smaller the average value of particle sizes, the smaller the appropriate size of a kernel in many cases. Thus, according to the particle size distribution estimation device 1, the contour of each granular particle can be extracted with high accuracy. As a result, the particle size distribution can be estimated with high accuracy.

In this example, since the opening is performed for the size of one kernel (in other words, the kernel size), the processing load can be suppressed as compared with a case where the opening is performed for each of a plurality of kernel sizes.

Note that, similarly to the particle size distribution estimation device 1 according to the second embodiment, the particle size distribution estimation device 1 according to the first modification of the fifth embodiment may perform binarizing for each of a plurality of threshold values different from each other, then, generate a plurality of binary images, and estimate a particle size distribution based on the generated plurality of binary images.

In addition, the particle size distribution estimation device 1 according to the first modification of the fifth embodiment may estimate a particle size distribution based on a plurality of captured images individually generated by imaging a target region in a plurality of states having different positions of at least one or some of a plurality of granular particles from each other, similarly to the particle size distribution estimation device 1A according to the first modification of the first embodiment.

In this case, the corrected binary image generation unit 204 may acquire the size of a kernel for each of the plurality of captured images based on a luminance change parameter acquired in the captured image, and use the size of the kernel acquired for the captured image in opening for the captured image.

Further, in this case, the corrected binary image generation unit 204 may acquire the size of the kernel for each of the plurality of captured images based on the luminance change parameter acquired in the captured image, and determine the average value of the plurality of sizes of the kernels acquired corresponding to the plurality of captured images as the size of a kernel to be used in opening for all of the plurality of captured images.

### Second Modification of Fifth Embodiment

Next, a particle size distribution estimation device according to a second modification of the fifth embodiment will be described. The particle size distribution estimation device according to the second modification of the fifth embodiment is different from the particle size distribution estimation device according to the first modification of the fifth embodiment in that the size of a kernel is determined based on a total edge distance in addition to a luminance change parameter. The difference will be mainly described below. Note that in the description of the second modification of the fifth embodiment, the same reference numerals as those used in the first modification of the fifth embodiment denote the same or substantially similar constituent elements.

### Functions

A corrected binary image generation unit 204 of the second modification of the fifth embodiment detects edges in a captured image subjected to pre-processing by the pre-processing unit 202, and acquires a total edge distance that is the total distance of the detected edges, similarly to the corrected binary image generation unit 204 of the fifth embodiment.

Further, the corrected binary image generation unit 204 of the second modification of the fifth embodiment acquires a luminance change parameter based on a change in luminance along a predetermined line in the captured image subjected to the pre-processing by the pre-processing unit 202, similarly to the corrected binary image generation unit 204 of the first modification of the fifth embodiment.

The corrected binary image generation unit 204 determines the size of a kernel to be used in the opening based on both the acquired total edge distance and the acquired luminance change parameter. In this example, the corrected binary image generation unit 204 determines the size of a kernel such that the size of the kernel is smaller as the acquired total edge distance is longer, and is smaller as the acquired luminance change parameter is larger.

### Operation

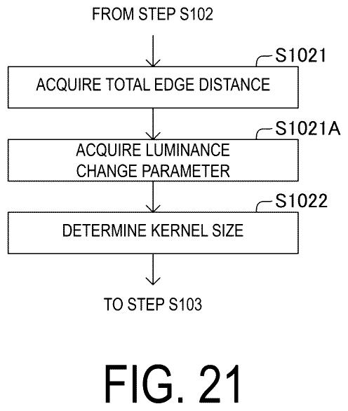

A particle size distribution estimation device 1 according to the second modification of the fifth embodiment performs processing in which processing of step S1021, step S1021A, and step S1022 illustrated in FIG. 21 is added between step S102 and step S103 of the processing illustrated in FIG. 3.

Thus, the information processing device 20 performs pre-processing on a captured image, then detects edges in the captured image subjected to the pre-processing, and acquires a total edge distance, which is the total distance of the detected edges (step S1021). Next, the information processing device 20 acquires a luminance change parameter in the captured image subjected to the pre-processing (step S1021A). Note that the information processing device 20 may perform the processing of step S1021 and step S1021A in an order opposite to the order illustrated in FIG. 21.

Next, the information processing device 20 determines the size of a kernel to be used in opening based on the total edge distance acquired in step S1021 and the luminance change parameter acquired in step S1021A (step S1022). Next, the information processing device 20 performs processing of step S103 to step S107, similarly to the information processing device 20 according to the first embodiment.

As described above, the particle size distribution estimation device 1 according to the second modification of the fifth embodiment exhibits functions and effects similar to those of the particle size distribution estimation device 1 according to the first embodiment.

Further, in the particle size distribution estimation device 1 according to the second modification of the fifth embodiment, the corrected binary image generation unit 204 determines the size of a kernel based on the total distance of edges detected in a captured image and a luminance change parameter acquired based on a change in luminance along a predetermined line in the captured image.

It should be noted that the average value of particle sizes and the width of a particle size distribution (in other words, the particle size range in a particle size distribution) have a strong correlation with the total distance of edges or a luminance change parameter. In addition, the average value of particle sizes and the width of a particle size distribution have a strong correlation also with an appropriate kernel size. Thus, according to the particle size distribution estimation device 1, the contour of each granular particle can be extracted with high accuracy. As a result, the particle size distribution can be estimated with high accuracy.

In this example, since the opening is performed for the size of one kernel (in other words, the kernel size), the processing load can be suppressed as compared with a case where the opening is performed for each of a plurality of kernel sizes.

Note that, similarly to the particle size distribution estimation device 1 according to the second embodiment, the particle size distribution estimation device 1 according to the second modification of the fifth embodiment may perform binarizing for each of a plurality of threshold values different from each other, then, generate a plurality of binary images, and estimate a particle size distribution based on the generated plurality of binary images.

In addition, the particle size distribution estimation device 1 according to the second modification of the fifth embodiment may estimate a particle size distribution based on a plurality of captured images individually generated by imaging a target region in a plurality of states having different positions of at least one or some of a plurality of granular particles from each other, similarly to the particle size distribution estimation device 1A according to the first modification of the first embodiment.

In this case, the corrected binary image generation unit 204 may acquire the size of a kernel based on the acquired total edge distance and luminance change parameter for each of the plurality of captured images, and use the size of the kernel acquired for the captured image in opening for the captured image.

Further, in this case, the corrected binary image generation unit 204 may acquire the size of a kernel based on the acquired total edge distance and luminance change parameter for each of the plurality of captured images, and determine the average value of the plurality of sizes of the kernels acquired corresponding to the plurality of captured images as the size of a kernel to be used in opening for all of the plurality of captured images.

### Third Modification of Fifth Embodiment

Next, a particle size distribution estimation device according to a third modification of the fifth embodiment will be described. The particle size distribution estimation device according to the third modification of the fifth embodiment is different from the particle size distribution estimation device according to the first modification of the first embodiment in that a resistance force received by a granular particle moving unit due to movement of the granular particles is detected and the size of a kernel is determined based on the detected resistance force. The difference will be mainly described below. Note that in the description of the third modification of the fifth embodiment, the same reference numerals as those used in the first modification of the first embodiment denote the same or substantially similar constituent elements.

### Configuration

As illustrated in FIG. 6, a particle size distribution estimation device 1B according to the third modification of the fifth embodiment includes the granular particle moving device 12B instead of the granular particle moving device 12 according to the first modification of the first embodiment.

The granular particle moving device 12B moves at least one or some of a plurality of granular particles in a target region, similarly to the granular particle moving device 12. In this example, the granular particle moving device 12B corresponds to a granular particle moving unit.

In this example, the granular particle moving device 12B is a bucket of a construction machine. In this example, the granular particle moving device 12B is driven by hydraulic pressure. Note that the granular particle moving device 12B may be driven by electric power. In this example, the imaging device 11 is positioned so as to face the granular particle moving device 12B. Note that the imaging device 11 may be mounted in or on the granular particle moving device 12B.

The granular particle moving device 12B includes a resistance force detector 121. The resistance force detector 121 detects a resistance force that the granular particle moving device 12B receives due to movement of granular particles. In this example, the granular particle moving device 12B detects the resistance force by detecting the magnitude of a hydraulic pressure that drives the granular particle moving device 12B. In this example, the resistance force detector 121 corresponds to a resistance force detection unit. Note that the resistance force detector 121 may detect a resistance force by using a force sensor, a pressure sensor, or a load sensor.

In this example, the resistance force detector 121 detects a bucket moving distance together with a resistance force. In this example, the resistance force detector 121 detects a driving amount (for example, a rotation angle, a displacement amount, and the like) of a drive unit (for example, an arm, a boom, and the like) for moving a bucket, and detects a bucket moving distance based on the detected driving amount. For example, the resistance force detector 121 may detect a driving amount by using a rotation angle sensor and a displacement sensor.

In this manner, in this example, the resistance force detector 121 detects a resistance force in association with a bucket moving distance.

### Functions

A corrected binary image generation unit 204 of the third modification of the fifth embodiment determines the size of a kernel to be used in opening based on a resistance force detected by the resistance force detector 121.

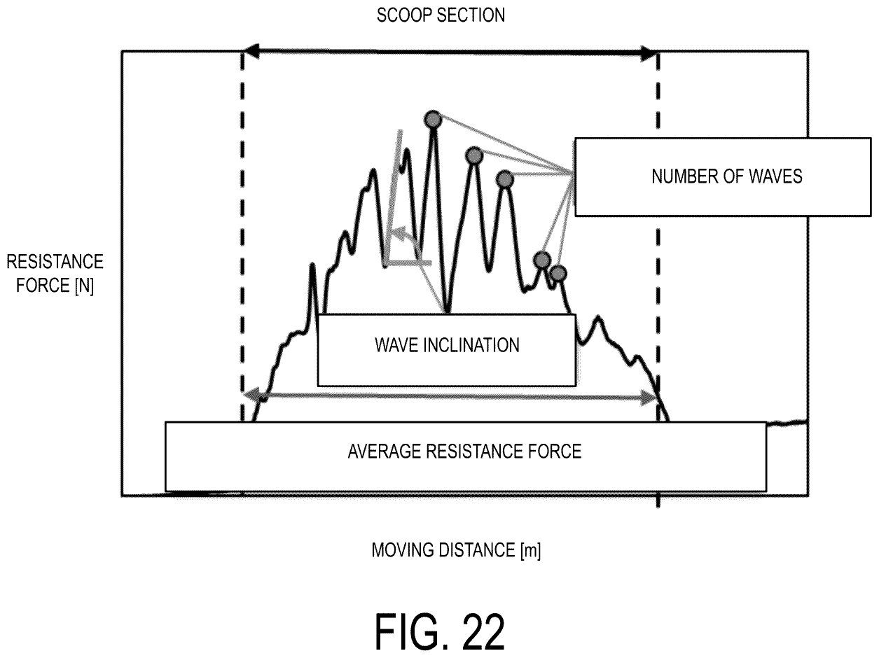

In this example, the corrected binary image generation unit 204 acquires a resistance force change parameter based on a change in detected resistance force with respect to bucket moving distance. FIG. 22 is a graph illustrating an example of the change in resistance force with respect to bucket moving distance.

In this example, the resistance force change parameter is an average resistance force that is a value obtained by averaging the resistance force in a scoop section. The scoop section is a range of the bucket moving distance in which the resistance force is larger than a predetermined threshold resistance force.

In this example, the corrected binary image generation unit 204 determines the size of a kernel such that the size of the kernel is smaller as the acquired resistance force change parameter is smaller.

Note that the resistance force change parameter may be, for example, a wave inclination, the number of waves, or the like instead of the average resistance force. The wave inclination is a value obtained by dividing a difference between a local minimum value and a local maximum value that are adjacent to each other in a change in resistance force by a distance difference that is a difference between two bucket moving distances corresponding to the local minimum value and the local maximum value, and averaging the obtained value in the scoop section. The number of waves is the number of local maximum values in the change in resistance force in the scoop section. In addition, the resistance force change parameter may be a parameter determined based on a power spectrum acquired by performing frequency analysis on the change in resistance force with respect to the bucket moving distance.

### Operation

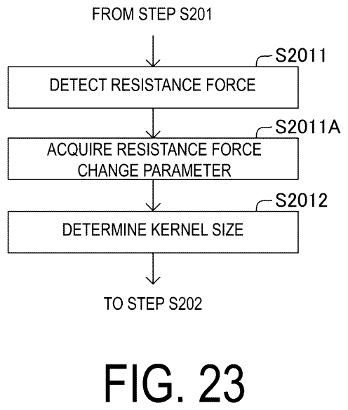

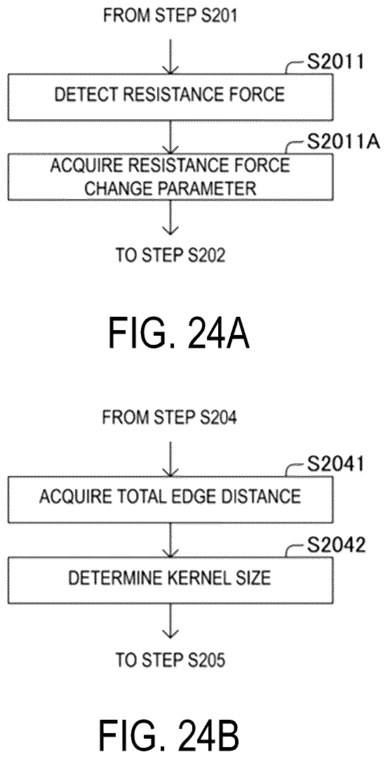

The particle size distribution estimation device 1B according to the third modification of the fifth embodiment performs processing in which processing of step S2011, step S2011A, and step S2012 illustrated in FIG. 23 is added between step S201 and step S202 of the processing illustrated in FIG. 5.

Thus, after the granular particle moving device 12B starts moving at least one or some of a plurality of granular particles in a target region in step S201, the resistance force detector 121 detects a resistance force received by the granular particle moving device 12B due to movement of the granular particles in association with the bucket moving distance in a period in which the granular particle moving device 12B moves the granular particles (step S2011).

Next, the information processing device 20 acquires a resistance force change parameter based on the resistance force detected in association with the bucket moving distance (step S2011A).

Next, the information processing device 20 determines the size of a kernel to be used in opening based on the resistance force change parameter acquired in step S2011A (step S2012). Next, the information processing device 20 performs the processing of step S202 to step S210, similarly to the information processing device 20 according to the first modification of the first embodiment.

As described above, the particle size distribution estimation device 1B according to the third modification of the fifth embodiment exhibits functions and effects similar to those of the particle size distribution estimation device 1A according to the first modification of the first embodiment.

Furthermore, the particle size distribution estimation device 1B according to the third modification of the fifth embodiment includes a resistance force detection unit (in this example, the resistance force detector 121) that detects a resistance force received by a granular particle moving unit (in this example, the granular particle moving device 12B) due to movement of granular particles. The corrected binary image generation unit 204 determines the size of a kernel based on the detected resistance force.

It is often observed that the average value of particle sizes and a resistance force have a strong correlation with each other. In addition, the smaller the average value of particle sizes, the smaller the appropriate size of a kernel in many cases. Thus, according to the particle size distribution estimation device 1B, the contour of each of the granular particles can be extracted with high accuracy. As a result, the particle size distribution can be estimated with high accuracy.

Furthermore, in the particle size distribution estimation device 1B according to the third modification of the fifth embodiment, the corrected binary image generation unit 204 determines the size of a kernel such that the size of the kernel is smaller as the acquired average resistance force is smaller.

The smaller the average value of particle sizes, the smaller the average resistance force in many cases. In addition, the smaller the average value of particle sizes, the smaller the appropriate size of a kernel in many cases. Thus, according to the particle size distribution estimation device 1B, the contour of each of the granular particles can be extracted with high accuracy. As a result, the particle size distribution can be estimated with high accuracy.

In this example, since the opening is performed for the size of one kernel (in other words, a kernel size), the processing load can be suppressed as compared with a case where the opening is performed for each of a plurality of kernel sizes.

Note that the particle size distribution estimation device 1B according to the third modification of the fifth embodiment may perform binarizing for each of a plurality of threshold values different from each other, then, generate a plurality of binary images, and estimate a particle size distribution based on the generated plurality of binary images, similarly to the particle size distribution estimation device 1A according to the first modification of the second embodiment.

Further, the particle size distribution estimation device 1B according to the third modification of the fifth embodiment may scoop up granular particles with a bucket a plurality of times.

In this case, the corrected binary image generation unit 204 may acquire, for each of the plurality of scoops, the size of a kernel based on a resistance force detected along with the scoop, and use the size of the kernel acquired along with the scoop in opening for a plurality of captured images acquired along with the scoop.

Further, in this case, the corrected binary image generation unit 204 may acquire, for each of the plurality of scoops, the size of a kernel based on a resistance force detected along with the scoop, and may determine the average value of the plurality of sizes of kernels acquired corresponding to the plurality of scoops as the size of a kernel to be used in opening for all of the plurality of captured images acquired along with the plurality of scoops.

### Fourth Modification of Fifth Embodiment

Next, a particle size distribution estimation device according to a fourth modification of the fifth embodiment will be described. The particle size distribution estimation device according to the fourth modification of the fifth embodiment is different from the particle size distribution estimation device according to the third modification of the fifth embodiment in that the size of a kernel is determined based on a total edge distance in addition to a resistance force change parameter. The difference will be mainly described below. Note that in the description of the fourth modification of the fifth embodiment, the same reference numerals as those used in the third modification of the fifth embodiment denote the same or substantially similar constituent elements.

### Functions

A corrected binary image generation unit 204 of the fourth modification of the fifth embodiment acquires a resistance force change parameter based on a change in resistance force detected by the resistance force detector 121 with respect to bucket moving distance, similarly to the corrected binary image generation unit 204 of the third modification of the fifth embodiment.

Furthermore, the corrected binary image generation unit 204 of the fourth modification of the fifth embodiment detects edges in the captured image subjected to pre-processing by the pre-processing unit 202, and acquires a total edge distance that is the total distance of the detected edges, similarly to the corrected binary image generation unit 204 of the fifth embodiment.

The corrected binary image generation unit 204 determines the size of a kernel to be used in opening based on both the acquired resistance force change parameter and the acquired total edge distance. In this example, the corrected binary image generation unit 204 determines the size of the kernel such that the size of the kernel is smaller as the acquired resistance force change parameter is smaller and is smaller as the acquired total edge distance is longer.

### Operation

A particle size distribution estimation device 1B according to the fourth modification of the fifth embodiment performs processing in which processing of step S2011 and step S2011A illustrated in FIG. 24A is added between step S201 and step S202 of the processing illustrated in FIG. 5, and processing of step S2041 and step S2042 illustrated in FIG. 24B is added between step S204 and step S205 of the processing illustrated in FIG. 5.

Thus, after the granular particle moving device 12B starts moving at least one or some of a plurality of granular particles in a target region in step S201, the resistance force detector 121 detects a resistance force received by the granular particle moving device 12B due to movement of the granular particles in association with the bucket moving distance in a period in which the granular particle moving device 12B moves the granular particles (step S2011).

Next, the information processing device 20 acquires a resistance force change parameter based on the resistance force detected in association with the bucket moving distance (step S2011A).

Next, similarly to the information processing device 20 according to the first modification of the first embodiment, the information processing device 20 performs processing of step S202 to step S204, then, detects edges in the captured image subjected to pre-processing, and acquires a total edge distance that is the total distance of the detected edges (step S2041).

Next, the information processing device 20 determines the size of a kernel to be used in opening based on the resistance force change parameter acquired in step S2011A and the total edge distance acquired in step S2041 (step S2042). Next, the information processing device 20 performs processing of step S205 to step S210, similarly to the information processing device 20 according to the first modification of the first embodiment.

As described above, the particle size distribution estimation device 1B according to the fourth modification of the fifth embodiment exhibits functions and effects similar to those of the particle size distribution estimation device 1B according to the third modification of the fifth embodiment.

Furthermore, in the particle size distribution estimation device 1B according to the fourth modification of the fifth embodiment, the corrected binary image generation unit 204 determines the size of a kernel based on the total distance of edges detected in a captured image in addition to a resistance force change parameter.

The smaller the average value of particle sizes, the smaller the average resistance force in many cases. In addition, the smaller the average value of particle sizes, the smaller the appropriate size of a kernel in many cases. Furthermore, the average value of particle sizes and the width of a particle size distribution (in other words, the particle size range in a particle size distribution) have a strong correlation with the total distance of edges. In addition, the average value of particle sizes and the width of a particle size distribution have a strong correlation also with an appropriate kernel size. Thus, according to the particle size distribution estimation device 1B, the contour of each of the granular particles can be extracted with high accuracy. As a result, the particle size distribution can be estimated with high accuracy.

In this example, since the opening is performed for the size of one kernel (in other words, a kernel size), the processing load can be suppressed as compared with a case where the opening is performed for each of a plurality of kernel sizes.

Note that the particle size distribution estimation device 1B according to the fourth modification of the fifth embodiment may use a luminance change parameter instead of the total distance of edges.

Further, the particle size distribution estimation device 1B according to the fourth modification of the fifth embodiment may perform binarizing for each of a plurality of threshold values different from each other, then, generate a plurality of binary images, and estimate a particle size distribution based on the generated plurality of binary images, similarly to the particle size distribution estimation device 1A according to the first modification of the second embodiment.

Further, the corrected binary image generation unit 204 may acquire, for each of a plurality of captured images, the size of a kernel based on the total distance of edges detected in the captured image and a resistance force change parameter, and may determine the average value of the plurality of sizes of kernels acquired corresponding to the plurality of captured images as the size of a kernel to be used in opening for all of the plurality of captured images.

Further, the particle size distribution estimation device 1B according to the fourth modification of the fifth embodiment may scoop up granular particles with a bucket a plurality of times.

In this case, the corrected binary image generation unit 204 may acquire, for each of the plurality of scoops, the size of a kernel based on a resistance force detected along with the scoop, and use the size of the kernel acquired along with the scoop in opening for a plurality of captured images acquired along with the scoop.

Further, in this case, the corrected binary image generation unit 204 may acquire, for each of the plurality of scoops, the size of a kernel based on a resistance force detected along with the scoop, and may determine the average value of the plurality of sizes of kernels acquired corresponding to the plurality of scoops as the size of a kernel to be used in opening for all of the plurality of captured images acquired along with the plurality of scoops.

### Sixth Embodiment

Next, a particle size distribution estimation device according to a sixth embodiment will be described. The particle size distribution estimation device according to the sixth embodiment is different from the particle size distribution estimation device according to the third embodiment in that a first kernel size is determined based on the total distance of edges and a second kernel size is determined based on a luminance change parameter. The difference will be mainly described below. Note that in the description of the sixth embodiment, the same reference numerals as those used in the third embodiment denote the same or substantially similar constituent elements.

### Functions

A corrected binary image generation unit 204 of the sixth embodiment detects edges in a captured image subjected to pre-processing by the pre-processing unit 202, and acquires a total edge distance that is the total distance of the detected edges, similarly to the corrected binary image generation unit 204 of the fifth embodiment.

Furthermore, the corrected binary image generation unit 204 of the sixth embodiment acquires a luminance change parameter based on a change in luminance along a predetermined line in the captured image subjected to the pre-processing by the pre-processing unit 202, similarly to the corrected binary image generation unit 204 of the first modification of the fifth embodiment.

In this example, a plurality of kernel sizes to be used by the corrected binary image generation unit 204 include a first kernel size and a second kernel size. In other words, in this example, the number of kernel sizes to be used by the corrected binary image generation unit 204 is two. In this example, the first kernel size is larger than the second kernel size.

The corrected binary image generation unit 204 determines the first kernel size based on the acquired total edge distance. In this example, the corrected binary image generation unit 204 determines the first kernel size such that the first kernel size is smaller as the acquired total edge distance is longer.

Furthermore, the corrected binary image generation unit 204 determines the second kernel size based on the determined first kernel size and the acquired luminance change parameter. In this example, the corrected binary image generation unit 204 determines the second kernel size such that the second kernel size is smaller as the determined first kernel size is smaller, and is smaller as the acquired luminance change parameter is larger.

Note that the corrected binary image generation unit 204 may determine the second kernel size based on the acquired luminance change parameter without being based on the determined first kernel size.

### Operation

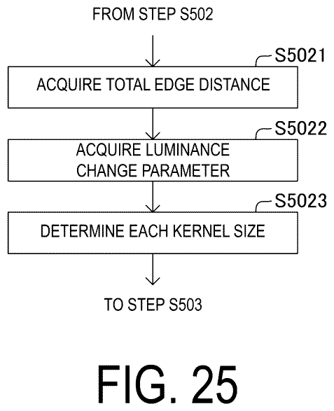

A particle size distribution estimation device 1 according to the sixth embodiment performs processing in which processing of step S5021, step S5022, and step S5023 illustrated in FIG. 25 is added between step S502 and step S503 of the processing illustrated in FIG. 15.

Thus, the information processing device 20 performs pre-processing on a captured image, then detects edges in the captured image subjected to the pre-processing, and acquires a total edge distance, which is the total distance of the detected edges (step S5021). Next, the information processing device 20 acquires a luminance change parameter in the captured image subjected to the pre-processing (step S5022). Note that the information processing device 20 may perform processing of step S5021 and step S5022 in an order opposite to the order illustrated in FIG. 25.

Next, the information processing device 20 determines each kernel size to be used in opening based on the total edge distance acquired in step S5021 and the luminance change parameter acquired in step S5022 (step S5023). Next, the information processing device 20 performs processing of step S503 to step S510, similarly to the information processing device 20 according to the third embodiment.

As described above, the particle size distribution estimation device 1 according to the sixth embodiment exhibits functions and effects similar to those of the particle size distribution estimation device 1 according to the third embodiment.

Furthermore, in the particle size distribution estimation device 1 according to the sixth embodiment, a plurality of kernel sizes include a first kernel size and a second kernel size. The corrected binary image generation unit 204 determines the first kernel size based on one of the total distance of edges detected in a captured image and a luminance change parameter acquired based on a change in luminance along a predetermined line in the captured image, and determines the second kernel size based on the other of the total distance of edges and the luminance change parameter.

The inventors of the present application have found that, when the width of a particle size distribution is relatively wide, the contour of each granular particle can be extracted with sufficiently high accuracy by performing opening for each of the two kernel sizes.

It should be noted that the average value of particle sizes and the width of a particle size distribution (in other words, the particle size range in a particle size distribution) have a strong correlation with the total distance of edges or a luminance change parameter. In addition, the average value of particle sizes and the width of a particle size distribution have a strong correlation also with an appropriate kernel size. Thus, according to the particle size distribution estimation device 1, when the width of a particle size distribution is relatively wide, the contour of each granular particle can be extracted with sufficiently high accuracy. As a result, the particle size distribution can be estimated with high accuracy.

Furthermore, in the particle size distribution estimation device 1 according to the sixth embodiment, the corrected binary image generation unit 204 determines the first kernel size such that the first kernel size is smaller as the total distance of edges detected in a captured image is longer.

Incidentally, the smaller the average value of particle sizes, the longer the total distance of edges in many cases. In addition, the smaller the average value of particle sizes, the smaller the appropriate size of a kernel in many cases. Thus, according to the particle size distribution estimation device 1, the contour of each granular particle can be extracted with high accuracy. As a result, the particle size distribution can be estimated with high accuracy.

Furthermore, in the particle size distribution estimation device 1 according to the sixth embodiment, the corrected binary image generation unit 204 determines the second kernel size such that the second kernel is smaller as a luminance change parameter acquired based on a change in luminance along a predetermined line in the captured image is larger.

Incidentally, the larger the width of a particle size distribution, the larger a luminance change parameter in many cases. In addition, the larger the width of a particle size distribution, the smaller the appropriate size of a kernel as the second kernel size in many cases. Thus, according to the particle size distribution estimation device 1, the contour of each granular particle can be extracted with high accuracy. As a result, the particle size distribution can be estimated with high accuracy.

Note that the particle size distribution estimation device 1 according to the sixth embodiment may determine the first kernel size based on a luminance change parameter instead of the total edge distance. In this case, the particle size distribution estimation device 1 may determine the second kernel size based on the determined first kernel size and the total edge distance. Moreover, in this case, the particle size distribution estimation device 1 may determine the second kernel size based on the total edge distance without being based on the determined first kernel size.

Further, the particle size distribution estimation device 1 according to the sixth embodiment may perform binarizing for each of a plurality of threshold values different from each other, then, generate a plurality of binary images, and estimate a particle size distribution based on the generated plurality of binary images, similarly to the particle size distribution estimation device 1 according to the fourth embodiment.

In addition, the particle size distribution estimation device 1 according to the sixth embodiment may estimate a particle size distribution based on a plurality of captured images individually generated by imaging a target region in a plurality of states having different positions of at least one or some of a plurality of granular particles from each other, similarly to the particle size distribution estimation device 1A according to the first modification of the first embodiment.

In this case, the corrected binary image generation unit 204 may acquire, for each of the plurality of captured images, the first kernel size and the second kernel size based on the total distance of edges detected in the captured image and a luminance change parameter acquired based on a change in luminance along a predetermined line in the captured image, and use the first kernel size and the second kernel size acquired for the captured image in opening for the captured image.

Moreover, in this case, the corrected binary image generation unit 204 may acquire, for each of the plurality of captured images, the first kernel size and the second kernel size based on the total distance of edges detected in the captured image and a luminance change parameter acquired based on a change in luminance along a predetermined line in the captured image. Furthermore, in this case, the corrected binary image generation unit 204 may determine the average value of the plurality of first kernel sizes individually acquired for the plurality of captured images as the first kernel size to be used in opening for all of the plurality of captured images. In addition, in this case, the corrected binary image generation unit 204 may determine the average value of the plurality of second kernel sizes individually acquired for the plurality of captured images as the second kernel size to be used in opening for all of the plurality of captured images.

### Seventh Embodiment

Next, a particle size distribution estimation device according to a seventh embodiment will be described. The particle size distribution estimation device according to the seventh embodiment is different from the particle size distribution estimation device according to the fourth embodiment in that a particle size distribution is estimated based on a plurality of captured images individually generated by imaging a target region in a plurality of states having different positions of at least one or some of the plurality of granular particles from each other, and that a resistance force received by a granular particle moving unit due to movement of the granular particles is detected, the first kernel size is determined based on the detected resistance force, and the second kernel size is determined based on the total edge distance. The difference will be mainly described below. Note that in the description of the seventh embodiment, the same reference numerals as those used in the fourth embodiment denote the same or substantially similar constituent elements.

### Configuration

As illustrated in FIG. 6, a particle size distribution estimation device 1B according to the seventh embodiment includes the granular particle moving device 12B, similarly to the particle size distribution estimation device 1B according to the third modification of the fifth embodiment, in addition to the configuration included in the particle size distribution estimation device 1 according to the fourth embodiment.

The granular particle moving device 12B moves at least one or some of a plurality of granular particles in a target region. In this example, the granular particle moving device 12B corresponds to a granular particle moving unit.

In this example, the granular particle moving device 12B is a bucket of a construction machine. In this example, the granular particle moving device 12B is driven by hydraulic pressure. Note that the granular particle moving device 12B may be driven by electric power. In this example, the imaging device 11 is positioned so as to face the granular particle moving device 12B. Note that the imaging device 11 may be mounted in or on the granular particle moving device 12B.

The granular particle moving device 12B includes a resistance force detector 121. The resistance force detector 121 detects a resistance force that the granular particle moving device 12B receives due to movement of granular particles. In this example, the granular particle moving device 12B detects the resistance force by detecting the magnitude of a hydraulic pressure that drives the granular particle moving device 12B. In this example, the resistance force detector 121 corresponds to a resistance force detection unit.

Note that the resistance force detector 121 may detect a resistance force by using a force sensor, a pressure sensor, or a load sensor.

In this example, the resistance force detector 121 detects a bucket moving distance together with a resistance force. In this example, the resistance force detector 121 detects a driving amount (for example, a rotation angle, a displacement amount, and the like) of a drive unit (for example, an arm, a boom, and the like) for moving a bucket, and detects a bucket moving distance based on the detected driving amount. For example, the resistance force detector 121 may detect a driving amount by using a rotation angle sensor and a displacement sensor.

In this manner, in this example, the resistance force detector 121 detects a resistance force in association with a bucket moving distance.

### Functions

A captured image acquisition unit 201 according to the seventh embodiment acquires a plurality of captured images individually generated by imaging a target region in a plurality of states having different positions of at least one or some of a plurality of granular particles from each other due to movement of the granular particles by the granular particle moving device 12B.

A pre-processing unit 202 of the seventh embodiment performs pre-processing on each of the plurality of captured images acquired by the captured image acquisition unit 201.

A binary image generation unit 203 of the seventh embodiment performs, for each captured image, binarizing on the captured image subjected to pre-processing by the pre-processing unit 202 by using each of a plurality of threshold values different from each other, thereby generating a plurality of binary images.

A corrected binary image generation unit 204 of the seventh embodiment performs, for each captured image, opening on each binary image generated by the binary image generation unit 203 for each of a plurality of sizes of kernels (in other words, kernel sizes) different from each other, thereby generating a plurality of corrected binary images.

A boundary information generation unit 205 of the seventh embodiment performs, for each captured image, boundary extracting on each of the plurality of corrected binary images generated for each binary image, thereby generating a plurality of pieces of boundary information.

A contour group information generation unit 206 of the seventh embodiment performs, for each captured image, discarding on each of the plurality of pieces of boundary information generated corresponding to the plurality of corrected binary images generated for each binary image, thereby generating contour group information.

A particle size distribution estimation unit 207 of the seventh embodiment estimates a particle size distribution based on a plurality of pieces of contour group information generated by the contour group information generation unit 206.

In this example, a plurality of kernel sizes to be used by the corrected binary image generation unit 204 include a first kernel size and a second kernel size. In other words, in this example, the number of kernel sizes to be used by the corrected binary image generation unit 204 is two. In this example, the first kernel size is larger than the second kernel size.

The corrected binary image generation unit 204 determines the first kernel size based on a resistance force detected by the resistance force detector 121. In this example, the corrected binary image generation unit 204 acquires a resistance force change parameter based on a change in the detected resistance force with respect to bucket moving distance.

In this example, the resistance force change parameter is an average resistance force that is a value obtained by averaging the resistance force in a scoop section. The scoop section is a range of the bucket moving distance in which the resistance force is larger than a predetermined threshold resistance force.

In this example, the corrected binary image generation unit 204 determines the first kernel size such that the first kernel size is smaller as the acquired resistance force change parameter is smaller.

Note that the resistance force change parameter may be, for example, a wave inclination, the number of waves, or the like instead of the average resistance force. The wave inclination is a value obtained by dividing a difference between a local minimum value and a local maximum value that are adjacent to each other in a change in resistance force by a distance difference that is a difference between two bucket moving distances corresponding to the local minimum value and the local maximum value, and averaging the obtained value in the scoop section. The number of waves is the number of local maximum values in the change in resistance force in the scoop section. In addition, the resistance force change parameter may be a parameter determined based on a power spectrum acquired by performing frequency analysis on the change in the resistance force with respect to the bucket moving distance.

Furthermore, the corrected binary image generation unit 204 detects edges in the captured image subjected to pre-processing by the pre-processing unit 202, and acquires a total edge distance that is the total distance of the detected edges, similarly to the corrected binary image generation unit 204 of the fifth embodiment.

The corrected binary image generation unit 204 determines the second kernel size based on the determined first kernel size and the acquired total edge distance. In this example, the corrected binary image generation unit 204 determines the second kernel size such that the second kernel size is smaller as the determined first kernel size is smaller and is smaller as the acquired total edge distance is longer.

Note that the corrected binary image generation unit 204 may determine the second kernel size based on the acquired total edge distance without being based on the determined first kernel size.

### Operation

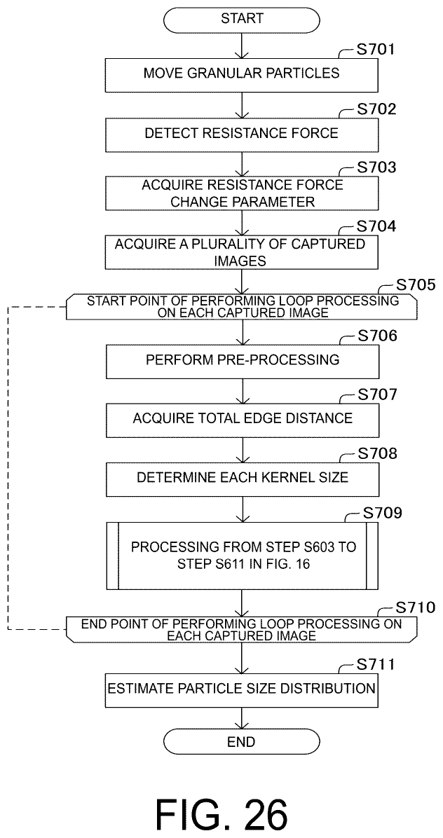

The particle size distribution estimation device 1B according to the seventh embodiment starts processing illustrated in FIG. 26 instead of the processing illustrated in FIG. 16. The granular particle moving device 12B moves at least one or some of a plurality of granular particles in a target region (step S701).

The resistance force detector 121 detects a resistance force that the granular particle moving device 12B receives due to movement of the granular particles in association with a bucket moving distance in a period in which the granular particle moving device 12B moves the granular particles (step S702).

Next, the information processing device 20 acquires a resistance force change parameter based on the resistance force detected in association with the bucket moving distance (step S703).

In parallel with the processing of step S702 and step S703, the information processing device 20 individually transmits M imaging commands to the imaging device 11 at M different time points from each other in a period in which the granular particle moving device 12B moves the granular particles, and receives M captured images output from the imaging device 11 to acquire the M captured images (step S704). M represents an integer of 2 or more.

Next, the information processing device 20 performs first loop processing using each of the M captured images acquired in step S704 as a processing target one by one in order (step S705 to step S710).

In the first loop processing, as in step S602 in FIG. 16, the information processing device 20 performs pre-processing on the captured image to be processed (step S706).

Next, the information processing device 20 detects edges in the captured image subjected to the pre-processing, and acquires a total edge distance, which is the total distance of the detected edges, similarly to the information processing device 20 according to the fifth embodiment (step S707).

Next, the information processing device 20 determines kernel sizes to be used in opening based on the resistance force change parameter acquired in step S703 and the total edge distance acquired in step S707 (step S708).

Next, similarly to the information processing device 20 according to the fourth embodiment, the information processing device 20 performs the processing of steps S603 to S611 in FIG. 16 (step S709).

Then, the information processing device 20 performs the first loop processing on all the acquired M captured images (steps S705 to S710), and then proceeds to step S711. Next, the information processing device 20 estimates a particle size distribution based on pieces of contour group information generated for the respective M captured images (step S711).

After that, the information processing device 20 ends the processing illustrated in FIG. 26.

As described above, the particle size distribution estimation device 1B according to the seventh embodiment exhibits functions and effects similar to those of the particle size distribution estimation device 1 according to the fourth embodiment.

Furthermore, the particle size distribution estimation device 1B according to the seventh embodiment includes a granular particle moving unit (in this example, the granular particle moving device 12B) that moves at least one or some of a plurality of granular particles in a target region, and a resistance force detection unit (in this example, the resistance force detector 121) that detects a resistance force received by the granular particle moving unit due to the movement.

A plurality of kernel sizes include a first kernel size and a second kernel size. The corrected binary image generation unit 204 determines the first kernel size based on the detected resistance force, and determines the second kernel size based on the total distance of edges detected in a captured image or a luminance change parameter acquired based on a change in luminance along a predetermined line in the captured image.

The inventors of the present application have found that, when the width of a particle size distribution is relatively wide, the contour of each granular particle can be extracted with sufficiently high accuracy by performing opening for each of the two kernel sizes.

It is often observed that the average value of particle sizes and a resistance force have a strong correlation with each other. In addition, the smaller the average value of particle sizes, the smaller the appropriate size of a kernel in many cases. Furthermore, the width of a particle size distribution (in other words, the particle size range in a particle size distribution) has a strong correlation with the total distance of edges or a luminance change parameter. Further, the width of a particle size distribution also has a strong correlation with an appropriate kernel size.

Thus, according to the particle size distribution estimation device 1B, when the range of a particle size distribution is relatively wide, the contour of each granular particle can be extracted with sufficiently high accuracy. As a result, the particle size distribution can be estimated with high accuracy.

Further, in the particle size distribution estimation device 1B according to the seventh embodiment, the corrected binary image generation unit 204 determines the first kernel size such that the first kernel size is smaller as the resistance force change parameter is smaller.

The smaller the average value of particle sizes, the smaller the resistance force change parameter in many cases. In addition, the smaller the average value of particle sizes, the smaller the appropriate size of a kernel in many cases. Thus, according to the particle size distribution estimation device 1B, the contour of each of the granular particles can be extracted with high accuracy. As a result, the particle size distribution can be estimated with high accuracy. Further, in the particle size distribution estimation device 1B according to the seventh embodiment, the corrected binary image generation unit 204 determines the second kernel size such that the second kernel size is smaller as the total distance of edges detected in the captured image is longer.

Incidentally, the larger the width of a particle size distribution, the longer the total distance of edges in many cases. In addition, the larger the width of a particle size distribution, the smaller the appropriate size of a kernel as the second kernel size in many cases. Thus, according to the particle size distribution estimation device 1B, the contour of each of the granular particles can be extracted with high accuracy. As a result, the particle size distribution can be estimated with high accuracy.

Note that the particle size distribution estimation device 1B according to the seventh embodiment may determine the second kernel size based on a luminance change parameter instead of the total edge distance.

Further, the particle size distribution estimation device 1B according to the seventh embodiment may perform binarizing for only one threshold value and thus estimate a particle size distribution.

Further, the corrected binary image generation unit 204 may acquire the second kernel size for each of a plurality of captured images based on the total distance of edges detected in the captured image, and determine the average value of the plurality of second kernel sizes acquired corresponding to the plurality of captured images as the second kernel size to be used in opening for all of the plurality of captured images.

Further, the particle size distribution estimation device 1B according to the seventh embodiment may scoop up granular particles with a bucket a plurality of times.

In this case, the corrected binary image generation unit 204 may acquire the first kernel size for each of the plurality of scoops based on a resistance force detected along with the scoop, and use the first kernel size acquired for the scoop in opening for a plurality of captured images acquired along with the scoop.

In this case, the corrected binary image generation unit 204 may acquire the first kernel size for each of the plurality of scoops based on a resistance force detected along with the scoop, and may determine the average value of the plurality of first kernel sizes acquired corresponding to the plurality of scoops as the first kernel size to be used in opening for all of the plurality of captured images acquired along with the plurality of scoops.

Note that the present disclosure is not limited to the embodiments described above. For example, various modifications that can be understood by those skilled in the art may be made to the above-described embodiments without departing from the spirit of the present disclosure.

### REFERENCE SIGNS LIST

1, 1A, 1B Particle size distribution estimation device
11 Imaging device
12, 12B Granular particle moving device
121 Resistance force detector
20 Information processing device
21 Processing device
22 Storage device
23 Connection device
201 Captured image acquisition unit
202 Pre-processing unit
203 Binary image generation unit
204 Corrected binary image generation unit
205 Boundary information generation unit
206 Contour group information generation unit
207 Particle size distribution estimation unit

1. A particle size distribution estimation device comprising:
captured image acquisition processor circuitry configured to acquire a captured image that is an image generated by imaging a target region including a plurality of granular particles at least partially overlapping each other;
a binary image generator configured to perform, on the captured image, binarizing that converts a value corresponding to each of a plurality of pixels constituting the captured image into a first value or a second value based on a threshold value, and thus to generate a binary image;
a corrected binary image generator configured to perform, on the binary image, opening including eroding and dilating, the eroding and the dilating being filtering using a kernel, and thus to generate a corrected binary image;
a boundary information generator configured to perform, on the corrected binary image, boundary extracting that extracts a boundary between a region having the first value and a region having the second value, and thus to generate boundary information representing the boundary;
a contour group information generator configured to perform, based on the boundary information, discarding that discards a contour candidate satisfying a predetermined discarding condition from among a contour candidate group that is a closed curve group included in the boundary represented by the boundary information, and thus to generate contour group information representing a contour group that is a contour candidate group not satisfying the predetermined discarding condition among the contour candidate group; and
particle size distribution estimation processor circuitry configured to estimate a particle size distribution that is a distribution of particle sizes of the plurality of granular particles, based on the contour group information.

2. The particle size distribution estimation device according to claim 1, further comprising:
a granular particle moving unit configured to move at least one or some of the plurality of granular particles in the target region; and
a resistance force detector configured to detect a resistance force received by the granular particle moving unit due to the movement, wherein
the corrected binary image generator is configured to determine a size of the kernel based on the detected resistance force.

3. The particle size distribution estimation device according to claim 2, wherein
the corrected binary image generator is configured to determine the size of the kernel based on a total distance of edges detected in the captured image or a luminance change parameter acquired based on a change in luminance along a predetermined line in the captured image.

4. The particle size distribution estimation device according to claim 1, wherein
the corrected binary image generator is configured to determine a size of the kernel based on at least one of a total distance of edges detected in the captured image and a luminance change parameter acquired based on a change in luminance along a predetermined line in the captured image.

5. The particle size distribution estimation device according to claim 1, wherein
the binary image generator is configured to perform the binarizing for each of a plurality of threshold values different from each other, and thus to generate a plurality of the binary images,
the corrected binary image generator is configured to perform the opening on each of the plurality of the binary images, and thus to generate a plurality of the corrected binary images,
the boundary information generator is configured to perform the boundary extracting on each of the plurality of the corrected binary images, and thus to generate a plurality of pieces of the boundary information,
the contour group information generator is configured to perform the discarding based on the plurality of pieces of the boundary information, and thus to generate the contour group information, and
the discarding condition includes a duplicate discarding condition that a center of another contour candidate is included inside a contour candidate to be determined.

6. The particle size distribution estimation device according to claim 1, wherein
the corrected binary image generator is configured to perform the opening for each of a plurality of kernel sizes different from each other, each kernel size being a size of the kernel, and thus to generate a plurality of the corrected binary images,
the boundary information generator is configured to perform the boundary extracting on each of the plurality of the corrected binary images, and thus to generate a plurality of pieces of the boundary information,
the contour group information generator is configured to perform the discarding based on the plurality of pieces of the boundary information, and thus to generate the contour group information, and
the discarding condition includes a duplicate discarding condition that a center of another contour candidate is included inside a contour candidate to be determined.

7. The particle size distribution estimation device according to claim 6, further comprising:
a granular particle moving unit configured to move at least one or some of the plurality of granular particles in the target region; and
a resistance force detector configured to detect a resistance force received by the granular particle moving unit due to the movement, wherein
the plurality of kernel sizes include a first kernel size and a second kernel size, and
the corrected binary image generator is configured to determine the first kernel size based on the detected resistance force, and is configured to determine the second kernel size based on a total distance of edges detected in the captured image or a luminance change parameter acquired based on a change in luminance along a predetermined line in the captured image.

8. The particle size distribution estimation device according to claim 6, wherein
the plurality of kernel sizes include a first kernel size and a second kernel size, and
the corrected binary image generator is configured to determine the first kernel size based on one of a total distance of edges detected in the captured image and a luminance change parameter acquired based on a change in luminance along a predetermined line in the captured image, and is configured to determine the second kernel size based on the other of the total distance of the edges and the luminance change parameter.

9. The particle size distribution estimation device according to claim 1, wherein
the discarding condition includes at least one of a first shape discarding condition that a circularity parameter is outside a first range, the circularity parameter increasing as a shape of a contour candidate to be determined approaches a circle, and a second shape discarding condition that a rectangularity parameter is outside a second range, the rectangularity parameter increasing as a shape of a contour candidate to be determined approaches a rectangle.

10. The particle size distribution estimation device according to claim 1, further comprising:
a granular particle moving unit configured to move at least one or some of the plurality of granular particles in the target region, wherein
the captured image acquisition processor circuitry is configured to acquire a plurality of the captured images individually generated by imaging the target region in a plurality of states having different positions of at least one or some of the plurality of granular particles from each other due to the movement,
the binary image generator is configured to perform the binarizing on each of the plurality of the captured images, and thus to generate a plurality of the binary images,
the corrected binary image generator is configured to perform the opening on each of the plurality of the binary images, and thus to generate a plurality of the corrected binary images,
the boundary information generator is configured to perform the boundary extracting on each of the plurality of the corrected binary images, and thus to generate a plurality of pieces of the boundary information,
the contour group information generator is configured to perform the discarding based on each of the plurality of pieces of the boundary information, and thus to generate a plurality of pieces of the contour group information, and
the particle size distribution estimation processor circuitry is configured to estimate the particle size distribution based on the plurality of pieces of the contour group information.

11. A particle size distribution estimation method comprising:
acquiring a captured image that is an image generated by imaging a target region including a plurality of granular particles at least partially overlapping each other;
performing, on the captured image, binarizing that converts a value corresponding to each of a plurality of pixels constituting the captured image into a first value or a second value based on a threshold value and thus generating a binary image;
performing, on the binary image, opening including eroding and dilating, the eroding and the dilating being filtering using a kernel, and thus generating a corrected binary image;
performing, on the corrected binary image, boundary extracting that extracts a boundary between a region having the first value and a region having the second value, and thus generating boundary information representing the boundary;
performing, based on the boundary information, discarding that discards a contour candidate satisfying a predetermined discarding condition from among a contour candidate group that is a closed curve group included in the boundary represented by the boundary information, and thus generating contour group information representing a contour group that is a contour candidate group not satisfying the predetermined discarding condition among the contour candidate group; and
estimating a particle size distribution that is a distribution of particle sizes of the plurality of granular particles, based on the contour group information.

12. A non-transitory computer-readable medium storing a particle size distribution estimation program that, when executed by a computer, causes the computer to perform a particle size distribution estimation method, the method comprising:
acquiring a captured image that is an image generated by imaging a target region including a plurality of granular particles at least partially overlapping each other;
binarizing, on the captured image, that converts a value corresponding to each of a plurality of pixels constituting the captured image into a first value or a second value based on a threshold value, and thus generating a binary image;
opening, on the binary image, including eroding and dilating, the eroding and the dilating being filtering using a kernel, and thus generating a corrected binary image;
boundary extracting, on the corrected binary image, that extracts a boundary between a region having the first value and a region having the second value, and thus generating boundary information representing the boundary;
discarding, based on the boundary information, that discards a contour candidate satisfying a predetermined discarding condition from among a contour candidate group that is a closed curve group included in the boundary represented by the boundary information, and thus generating contour group information representing a contour group that is a contour candidate group not satisfying the predetermined discarding condition among the contour candidate group; and
estimating a particle size distribution that is a distribution of particle sizes of the plurality of granular particles, based on the contour group information.
